(19) United States
(12) Patent Application Publication
(10) Pub. No.: US 2025/0318034 A1
(43) Pub. Date: Oct. 9, 2025

(54) CONTROL DEVICE FOR ILLUMINATION DEVICE

(71) Applicant: Japan Display Inc., Tokyo (JP)

(72) Inventor: Gang SHAO, Tokyo (JP)

(21) Appl. No.: 19/241,905

(22) Filed: Jun. 18, 2025

Related U.S. Application Data
(63) Continuation of application No. PCT/JP2023/042513, filed on Nov. 28, 2023.

(30) Foreign Application Priority Data
Dec. 21, 2022 (JP) 2022-204268

(51) Int. Cl. H05B 47/175; F21V 14/00; G06F 3/0484; G06F 3/0488

(52) U.S. Cl. CPC H05B 47/196; F21V 14/003; G06F 3/0484; G06F 3/0488

(57) ABSTRACT

According to an aspect, a control device for an illumination device includes a storage circuit configured to store a first detection value detected at a first time and a second detection value detected at a second time later than the first time. The control device has a first adjustment mode in which a light distribution shape is adjusted with a first adjustment step, and a second adjustment mode in which the light distribution shape is adjusted with a second adjustment step narrower than the first adjustment step. When a time during which the magnitude of a movement amount of a touch detection position calculated by subtracting the first detection value from the second detection value remains equal to or smaller than a predetermined movement amount threshold becomes equal to or longer than a predetermined time threshold in the first adjustment mode, a transition to the second adjustment mode is made.

### CROSS-REFERENCE TO RELATED APPLICATION

This application claims the benefit of priority from Japanese Patent Application No. 2022-204268 filed on Dec. 21, 2022 and International Patent Application No. PCT/JP2023/042513 filed on Nov. 28, 2023, the entire contents of which are incorporated herein by reference.

### BACKGROUND

### 1. Technical Field

What is disclosed herein relates to a control device for an illumination device.

### 2. Description of the Related Art

In a conventional illumination instrument, a light source such as an LED is combined with a thin lens provided with a prism pattern, and the distance between the light source and the thin lens is changed to change a light distribution angle. For example, an illumination instrument has been disclosed (refer to Japanese Patent Application Laid-open Publication No. H02-065001, for example) in which the front of a transparent light bulb is covered by a liquid crystal light adjustment element and the transmittance of a liquid crystal layer is changed to switch between directly-reaching light and scattering light.

For example, in an illumination device including a liquid crystal cell for p wave polarization and a liquid crystal cell for s wave polarization, the diffusion degree of light in two directions can be controlled by driving the respective liquid crystal cells. For such an illumination device capable of controlling the diffusion degree of light in two directions, it is desired for a control device to be able to coarsely adjust the diffusion degree of light in the two directions (hereinafter also referred to as “coarse adjustment”) and then finely adjust the diffusion degree (hereinafter also referred to as “fine adjustment”).

For the foregoing reasons, there is a need for a control device for an illumination device capable of seamlessly making a transition from a coarse adjustment mode to a fine adjustment mode.

### SUMMARY

According to an aspect, a control device for an illumination device that is configured to control a plurality of illumination devices each capable of setting a light distribution shape of light emitted from a light source in two directions of a first direction and a second direction intersecting the first direction. The control device includes: a touch sensor including a detection region in which a plurality of detection elements are provided; a display panel provided with a display region that overlaps the detection region of the touch sensor in a plan view and configured to display an adjustment screen for the light distribution shape in the display region; and a storage circuit configured to store a first detection value and a second detection value, the first detection value being detected at a first time in an adjustment region provided on the adjustment screen, the second detection value being detected at a second time later than the first time in the adjustment region. The control device has a first adjustment mode in which the light distribution shape is adjusted with a first adjustment step, and a second adjustment mode in which the light distribution shape is adjusted with a second adjustment step narrower than the first adjustment step. When a time during which the magnitude of a movement amount of a touch detection position calculated by subtracting the first detection value from the second detection value remains equal to or smaller than a predetermined movement amount threshold becomes equal to or longer than a predetermined first time threshold in the first adjustment mode, a transition to the second adjustment mode is made.

### BRIEF DESCRIPTION OF THE DRAWINGS

FIG. 1A is a side view illustrating an example of an illumination device according to an embodiment;

FIG. 1B is a perspective view illustrating an example of an optical element according to the embodiment;

FIG. 2 is a schematic plan view of a first substrate when viewed in a Dz direction;

FIG. 3 is a schematic plan view of a second substrate when viewed in the Dz direction;

FIG. 4 is a see-through diagram of a liquid crystal cell in which the first substrate and the second substrate are stacked in the Dz direction;

FIG. 5 is a cross-sectional view along line A-A′ illustrated in FIG. 4;

FIG. 6A is a diagram illustrating the alignment direction of an alignment film of the first substrate;

FIG. 6B is a diagram illustrating the alignment direction of an alignment film of the second substrate;

FIG. 7 is a multilayered structure diagram of the optical element according to the embodiment;

FIG. 8A is a conceptual diagram for description of change in shape of light by the optical element according to the embodiment;

FIG. 8B is a conceptual diagram for description of change in shape of light by the optical element according to the embodiment;

FIG. 8C is a conceptual diagram for description of change in shape of light by the optical element according to the embodiment;

FIG. 8D is a conceptual diagram for description of change in shape of light by the optical element according to the embodiment;

FIG. 9 is a conceptual diagram for conceptually describing control of the light diffusion degree of the illumination device according to the embodiment;

FIG. 10 is a schematic view illustrating an example of the configuration of an illumination system according to the embodiment;

FIG. 11 is an exterior diagram illustrating an example of a control device according to the embodiment;

FIG. 12 is a conceptual diagram illustrating an example of a touch detection region of a touch sensor;

FIG. 13 is a diagram illustrating an example of the control block configuration of the control device according to the embodiment;

FIG. 14 is a diagram illustrating an example of the control block configuration of the illumination device according to the embodiment;

FIG. 15A is a conceptual diagram illustrating an example of the display aspect of a coarse adjustment mode screen on a control device according to a first embodiment;

FIG. 15B is a conceptual diagram illustrating an example of the display aspect of the coarse adjustment mode screen on the control device according to the first embodiment;

FIG. 15C is a conceptual diagram illustrating an example of the display aspect of the coarse adjustment mode screen on the control device according to the first embodiment;

FIG. 15D is a conceptual diagram illustrating an example of the display aspect of the coarse adjustment mode screen on the control device according to the first embodiment;

FIG. 16 is a diagram for description of the relation between the position on the coarse adjustment mode screen on the control device according to the first embodiment and the light diffusion degree;

FIG. 17A is a conceptual diagram illustrating a first example of the display aspect of a fine adjustment mode screen on the control device according to the first embodiment;

FIG. 17B is a conceptual diagram illustrating the first example of the display aspect of the fine adjustment mode screen on the control device according to the first embodiment;

FIG. 18A is a conceptual diagram illustrating a second example of the display aspect of the fine adjustment mode screen on the control device according to the first embodiment;

FIG. 18B is a conceptual diagram illustrating the second example of the display aspect of the fine adjustment mode screen on the control device according to the first embodiment;

FIG. 19A is a first diagram for description of the relation between the position on the fine adjustment mode screen on the control device according to the first embodiment and the light diffusion degree;

FIG. 19B is a second diagram for description of the relation between the position on the fine adjustment mode screen on the control device according to the first embodiment and the light diffusion degree;

FIG. 20 is a flowchart illustrating an example of initial setting processing by the control device for an illumination device according to the first embodiment;

FIG. 21 is a conceptual diagram illustrating an example of a storage region in the control device for an illumination device according to the first embodiment;

FIG. 22 is a flowchart illustrating an example of the overall flow of illumination control processing by the control device for an illumination device according to the first embodiment;

FIG. 23 is a flowchart illustrating an example of processing by the control device for an illumination device according to the first embodiment in a coarse adjustment mode in an X direction;

FIG. 24 is a flowchart illustrating an example of processing by the control device for an illumination device according to the first embodiment in a fine adjustment mode in the X direction;

FIG. 25 is a flowchart illustrating an example of processing by the control device for an illumination device according to the first embodiment in the coarse adjustment mode in a Y direction;

FIG. 26 is a flowchart illustrating an example of processing by the control device for an illumination device according to the first embodiment in the fine adjustment mode in the Y direction;

FIG. 27 is a flowchart illustrating an example of the overall flow of illumination control processing by a control device for an illumination device according to a second embodiment;

FIG. 28 is a flowchart illustrating an example of processing by the control device for an illumination device according to the second embodiment in an automatic fine adjustment mode in the X direction; and

FIG. 29 is a flowchart illustrating an example of processing by the control device for an illumination device according to the second embodiment in the automatic fine adjustment mode in the Y direction.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate. What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure In the present specification and drawings, any element same as that already described with reference to an already described drawing is denoted by the same reference sign, and detailed description thereof is omitted as appropriate in some cases.

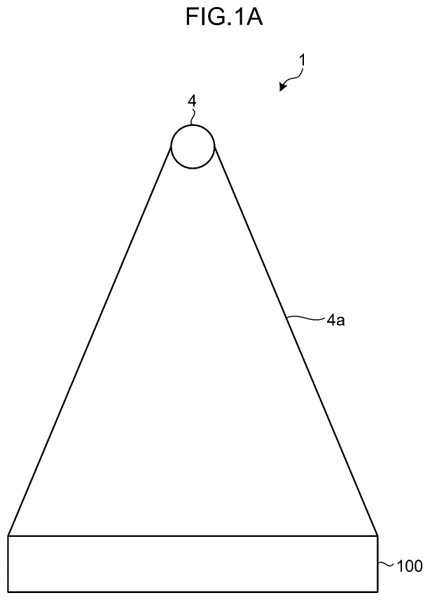

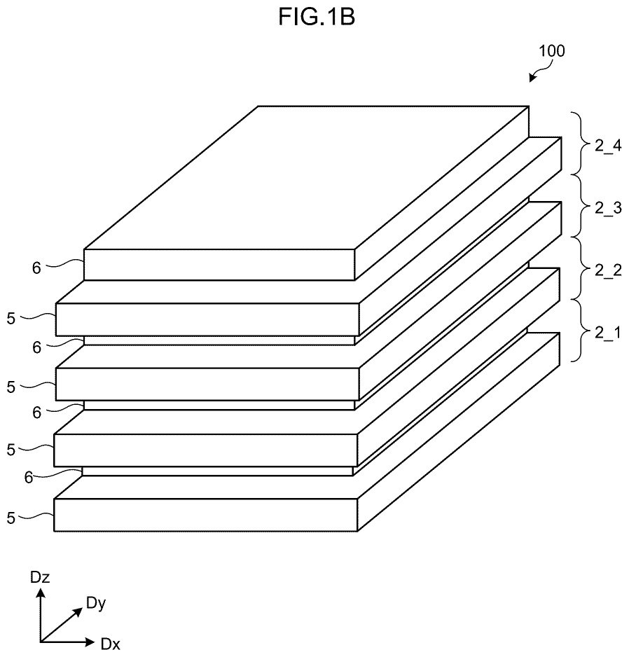

FIG. 1A is a side view illustrating an example of an illumination device 1 according to an embodiment. FIG. 1B is a perspective view illustrating an example of an optical element 100 according to the embodiment. As illustrated in FIG. 1A, the illumination device 1 includes a light source 4, a reflector 4a, and the optical element 100. As illustrated in FIG. 1B, the optical element 100 includes a first liquid crystal cell 2_1, a second liquid crystal cell 2_2, a third liquid crystal cell 2_3, and a fourth liquid crystal cell 2_4. The light source 4 is configured with, for example, a light emitting diode (LED). The reflector 4a is a component that condenses light from the light source 4 to the optical element 100.

In FIG. 1B, a Dz direction indicates the emission direction of light from the light source 4 and the reflector 4a. The optical element 100 has a configuration in which the first liquid crystal cell 2_1, the second liquid crystal cell 2_2, the third liquid crystal cell 2_3, and the fourth liquid crystal cell 2_4 are stacked in the Dz direction. In the present disclosure, the optical element 100 has a configuration in which the first liquid crystal cell 2_1, the second liquid crystal cell 2_2, the third liquid crystal cell 2_3, and the fourth liquid crystal cell 2_4 are sequentially stacked from the light source 4 side (lower side in FIG. 1B). In FIG. 1B, one direction in a plane orthogonal to the Dz direction and parallel to stacking surfaces of the first liquid crystal cell 2_1, the second liquid crystal cell 2_2, the third liquid crystal cell 2_3, and the fourth liquid crystal cell 2_4 is defined as a Dx direction (first direction), and a direction orthogonal to both the Dx direction and the Dz direction is defined as a Dy direction (second direction).

The first liquid crystal cell 2_1, the second liquid crystal cell 2_2, the third liquid crystal cell 2_3, and the fourth liquid crystal cell 2_4 have the same configuration. In the present disclosure, the first liquid crystal cell 2_1 and the fourth liquid crystal cell 2_4 are liquid crystal cells for p-wave polarization. The second liquid crystal cell 2_2 and the third liquid crystal cell 2_3 are liquid crystal cells for s-wave polarization. Hereinafter, the first liquid crystal cell 2_1, the second liquid crystal cell 2_2, the third liquid crystal cell 2_3, and the fourth liquid crystal cell 2_4 are also collectively referred to as “liquid crystal cells 2”.

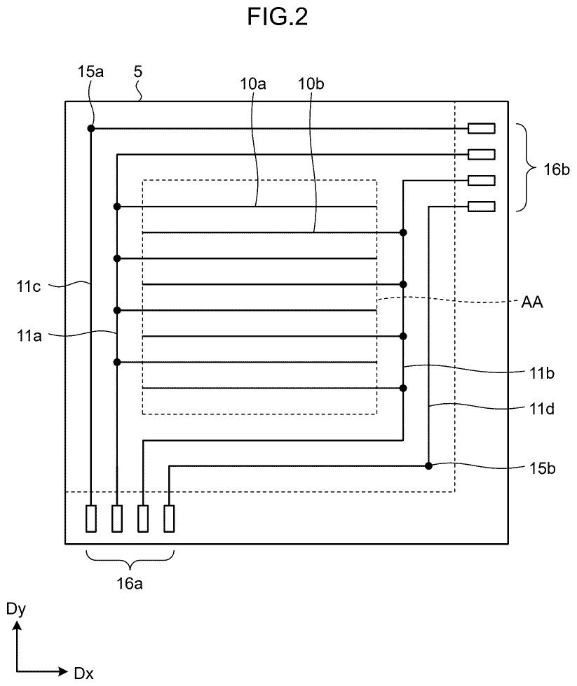

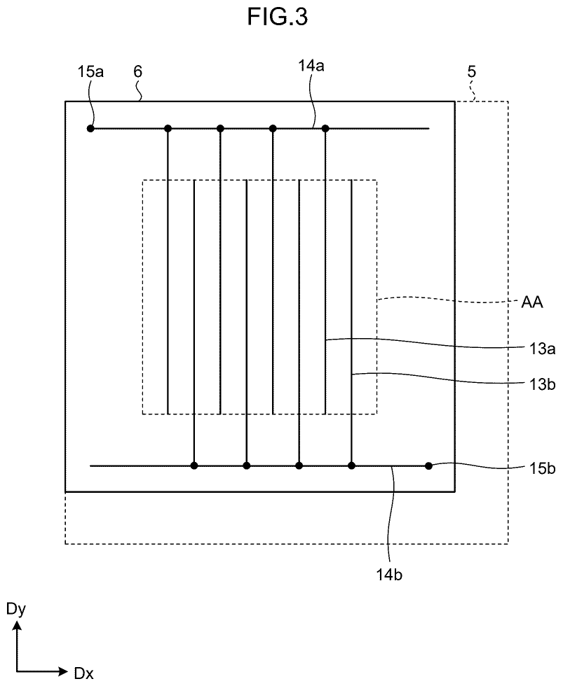

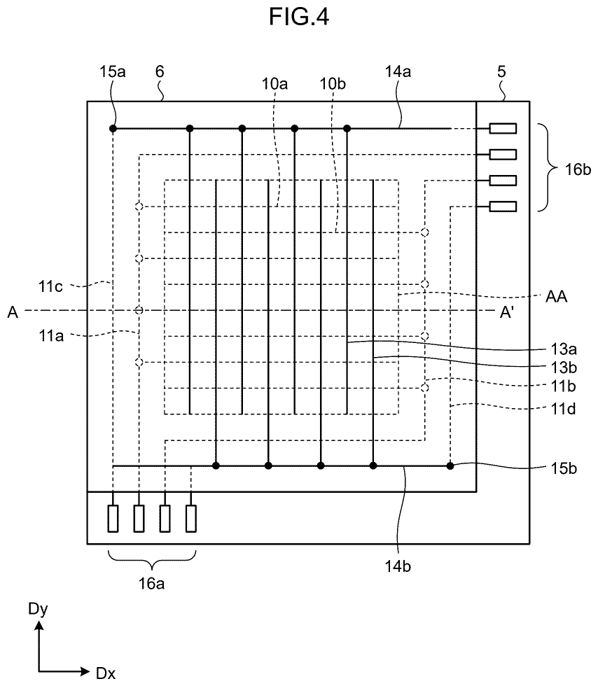

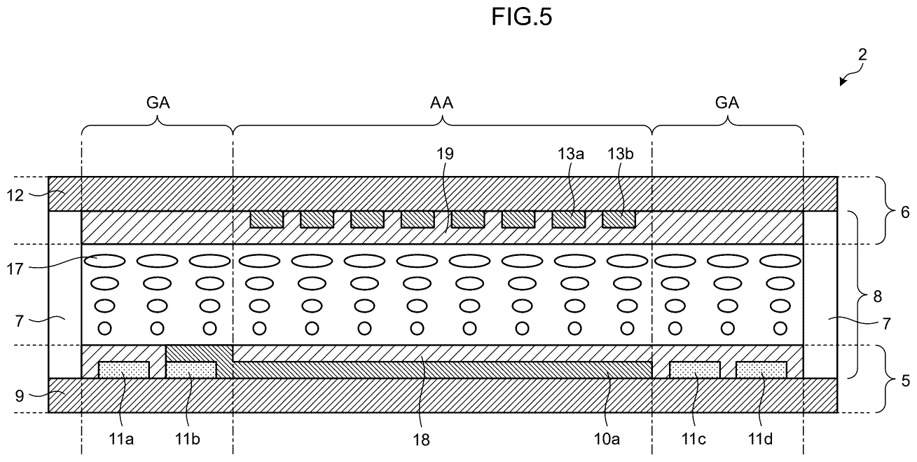

Each liquid crystal cell 2 includes a first substrate 5 and a second substrate 6. FIG. 2 is a schematic plan view of the first substrate 5 when viewed in the Dz direction. FIG. 3 is a schematic plan view of the second substrate 6 when viewed in the Dz direction. In FIG. 3, drive electrodes are visible through the substrates, but for clarity, the drive electrodes and wiring lines are illustrated with solid lines. FIG. 4 is a see-through view of a liquid crystal cell in which the first substrate 5 and the second substrate 6 are stacked in the Dz direction. In FIG. 4 as well, for clarity, the drive electrodes and wiring lines on the second substrate side are illustrated with solid lines, and the drive electrodes and wiring lines on the first substrate side are illustrated with dotted lines. FIG. 5 is a sectional view along line A-A′ illustrated in FIG. 4. FIGS. 2, 3, 4, and 5 exemplarily illustrate the third liquid crystal cell 2_3 and the fourth liquid crystal cell 2_4 in which drive electrodes 10a and 10b of the first substrate 5 extend in the Dx direction and drive electrodes 13a and 13b of the second substrate 6 extend in the Dy direction.

As illustrated in FIG. 5, the liquid crystal cell 2 includes a liquid crystal layer 8 sealed around its periphery by a sealing member 7 between the first substrate 5 and the second substrate 6.

The liquid crystal layer 8 modulates light passing through the liquid crystal layer 8 in accordance with the state of electric field. As liquid crystal molecules, positive-type nematic liquid crystals are used, but other liquid crystals with the same effects may be used.

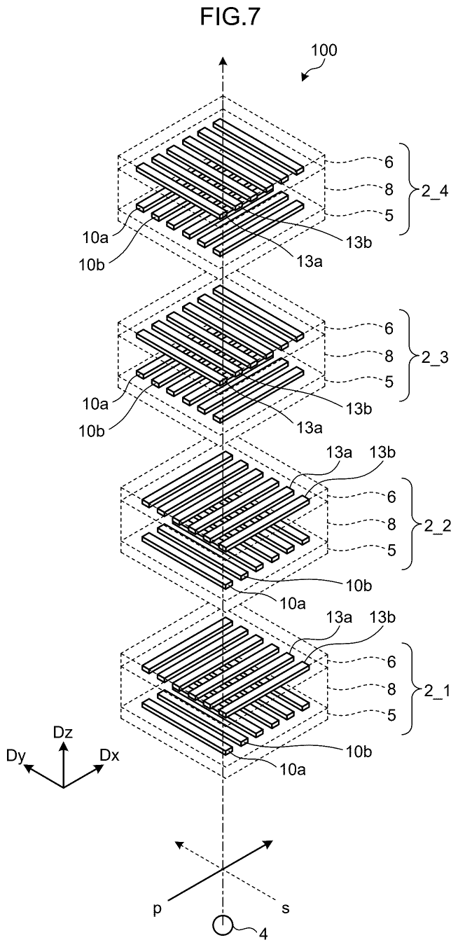

As illustrated in FIG. 2, the drive electrodes 10a and 10b, metal lines 11a and 11b, and metal lines 11c and 11d are provided on the liquid crystal layer 8 side of a base member 9 of the first substrate 5. The metal lines 11a and 11b supply drive voltage that is applied to the drive electrodes 10a and 10b, and the metal lines 11c and 11d supply drive voltage that is applied to the drive electrodes 13a and 13b (refer to FIG. 3) provided on the second substrate 6 to be described later. The metal lines 11a, 11b, 11c, and 11d are provided in a wiring layer of the first substrate 5. The metal lines 11a, 11b, 11c, and 11d are provided to be spaced apart in the wiring layer on the first substrate 5. Hereinafter, the drive electrodes 10a and 10b are simply referred to as “drive electrodes 10” in some cases. The metal lines 11a, 11b, 11c, and 11d are referred to as “first metal lines 11” in some cases. As illustrated in FIGS. 2 and 7, in the third liquid crystal cell 2_3 and the fourth liquid crystal cell 2_4, the drive electrodes 10 on the first substrate 5 extend in the Dx direction. In the first liquid crystal cell 2_1 and the second liquid crystal cell 2_2, the drive electrodes 10 on the first substrate 5 extend in the Dy direction.

As illustrated in FIG. 3, the drive electrodes 13a and 13b, and a plurality of metal lines 14a and 14b that supply drive voltage applied to the drive electrodes 13 are provided on the liquid crystal layer 8 side of a base member 12 of the second substrate 6 illustrated in FIG. 5. The metal lines 14a and 14b are provided in a wiring layer of the second substrate 6. The metal lines 14a and 14b are provided to be spaced apart in the wiring layer on the second substrate 6. Hereinafter, the drive electrodes 13a and 13b are simply referred to as “drive electrodes 13” in some cases. The metal lines 14a and 14b are referred to as “second metal lines 14” in some cases. As illustrated in FIGS. 3 and 7, in the third liquid crystal cell 2_3 and the fourth liquid crystal cell 2_4, the drive electrodes 13 on the second substrate 6 extend in the Dy direction. In the first liquid crystal cell 2_1 and the second liquid crystal cell 2_2, the drive electrodes 13 on the second substrate 6 extend in the Dx direction.

The drive electrodes 10 and the drive electrodes 13 are light-transmitting electrodes formed of a light-transmitting conductive material (light-transmitting conductive oxide) such as indium tin oxide (ITO). The first substrate 5 and the second substrate 6 are light-transmitting substrates such as glass or resin. The first metal lines 11 and the second metal lines 14 are formed of at least one metallic material selected from aluminum (Al), copper (Cu), silver (Ag), molybdenum (Mo), and alloys thereof. The first metal lines 11 and the second metal lines 14 may be stacked bodies of a plurality of layers using one or more of these metallic materials. At least one metallic material selected from aluminum (Al), copper (Cu), silver (Ag), molybdenum (Mo), and alloys thereof has lower resistance than light-transmitting conductive oxide such as ITO.

The metal line 11c of the first substrate 5 and the metal line 14a of the second substrate 6 are coupled by a conduction part 15a made of, for example, conductive paste. The metal line 11d of the first substrate 5 and the metal line 14b of the second substrate 6 are coupled by a conduction part 15b made of, for example, conductive paste.

Coupling (flex-on-board) terminal parts 16a and 16b that are coupled to non-illustrated flexible printed circuits (FPC) are provided in regions on the first substrate 5, which do not overlap the second substrate 6 when viewed in the Dz direction. The coupling terminal parts 16a and 16b each include four coupling terminals corresponding to the metal lines 11a, 11b, 11c, and 11d, respectively.

The coupling terminal parts 16a and 16b are provided in the wiring layer of the first substrate 5. Drive voltage to be applied to the drive electrodes 10a and 10b on the first substrate 5 and the drive electrodes 13a and 13b on the second substrate 6 is supplied to the liquid crystal cell 2 from an FPC coupled to the coupling terminal part 16a or the coupling terminal part 16b. Hereinafter, the coupling terminal parts 16a and 16b are simply referred to as “coupling terminal parts 16” in some cases.

As illustrated in FIG. 4, in the liquid crystal cell 2, the first substrate 5 and the second substrate 6 are stacked in the Dz direction (irradiation direction of light), and the drive electrodes 10 on the first substrate 5 intersect the drive electrodes 13 on the second substrate 6 when viewed in the Dz direction. In the liquid crystal cell 2 thus configured, the alignment direction of liquid crystal molecules 17 in the liquid crystal layer 8 can be controlled by supplying drive voltage to the drive electrodes 10 on the first substrate 5 and the drive electrodes 13 on the second substrate 6. A region in which the alignment direction of the liquid crystal molecules 17 in the liquid crystal layer 8 can be controlled is referred to as an “effective region AA”. The refractive index distribution of the liquid crystal layer 8 is changed in the effective region AA, whereby the diffusion degree of light transmitted through the effective region AA of the liquid crystal cell 2 can be controlled. A region outside the effective region AA, where the liquid crystal layer 8 is sealed by the sealing member 7 is referred to as a “peripheral region GA” (refer to FIG. 5).

As illustrated in FIG. 5, the drive electrodes 10 (in FIG. 5, the drive electrode 10a) in the effective region AA of the first substrate 5 are covered by an alignment film 18. The drive electrodes 13 (in FIG. 5, the drive electrodes 13a and 13b) in the effective region AA of the second substrate 6 are covered by an alignment film 19. The alignment direction of the liquid crystal molecules is different between the alignment film 18 and the alignment film 19.

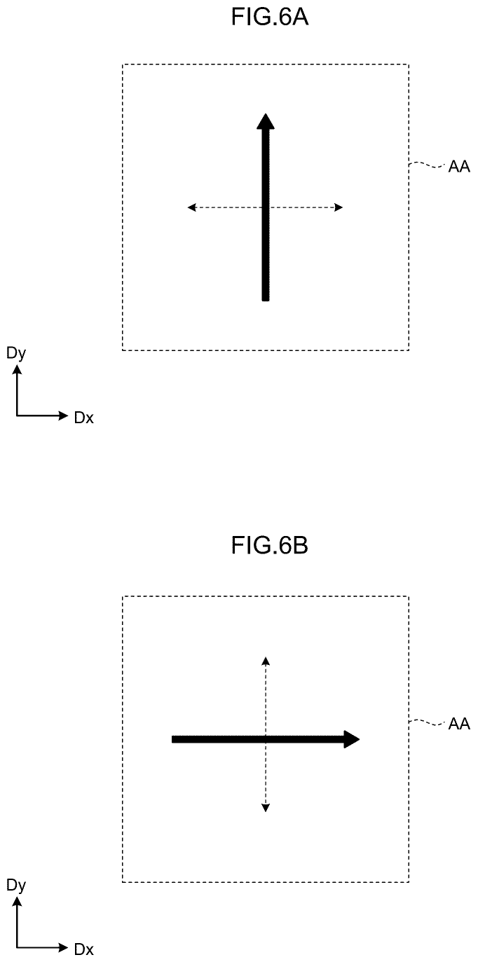

FIG. 6A is a diagram illustrating the alignment direction of the alignment film of the first substrate 5. FIG. 6B is a diagram illustrating the alignment direction of the alignment film of the second substrate 6.

As illustrated in FIGS. 6A and 6B, the alignment direction of the alignment film 18 of the first substrate 5 and the alignment direction of the alignment film 19 of the second substrate 6 are directions intersecting each other in a plan view. Specifically, as illustrated with a solid arrow in FIG. 6A, the alignment direction of the alignment film 18 of the first substrate 5 is orthogonal to the extending direction of the drive electrodes 10a and 10b, which is illustrated with a dashed arrow in FIG. 6A. As illustrated with a solid arrow in FIG. 6B, the alignment direction of the alignment film 19 of the second substrate 6 is orthogonal to the extending direction of the drive electrodes 13a and 13b, which is illustrated with a dashed arrow in FIG. 6B. In the following description, the extending directions of the drive electrodes 10 and 13 are orthogonal to the alignment directions of the alignment films 18 and 19 covering them, but these may intersect at an angle other than being orthogonal, for example, in the angle range of 85° to 90°. The drive electrodes 10 on the first substrate 5 side and the drive electrodes 13 on the second substrate 6 side are preferably orthogonal to each other but may intersect, for example, in the angle range of 85° to 90°. The alignment directions of the alignment films 18 and 19 are formed by rubbing processing or light alignment processing.

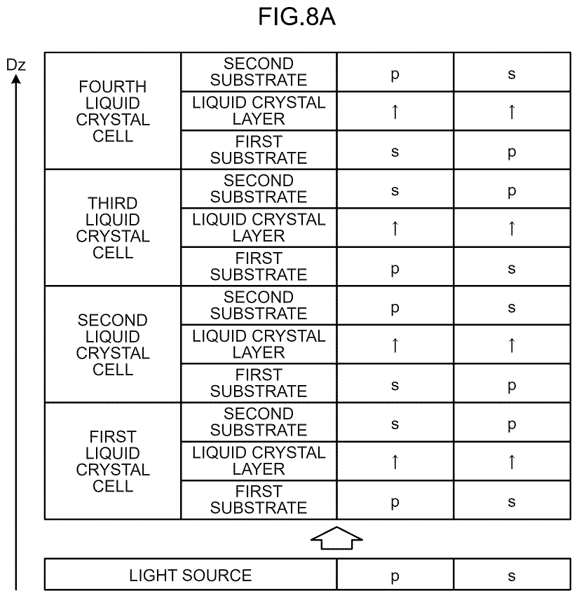

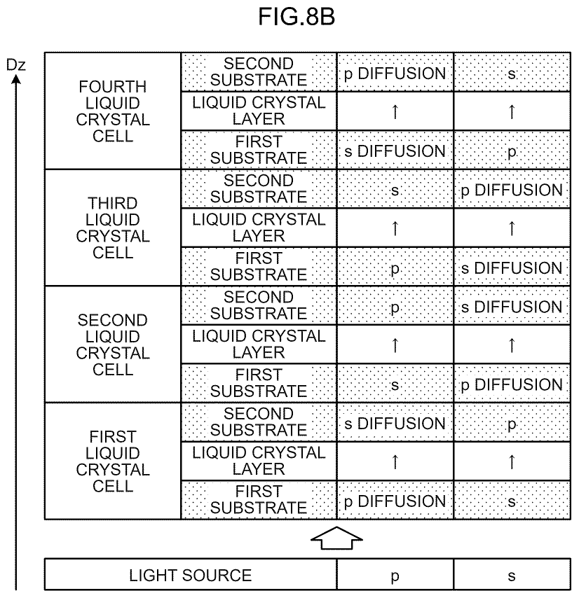

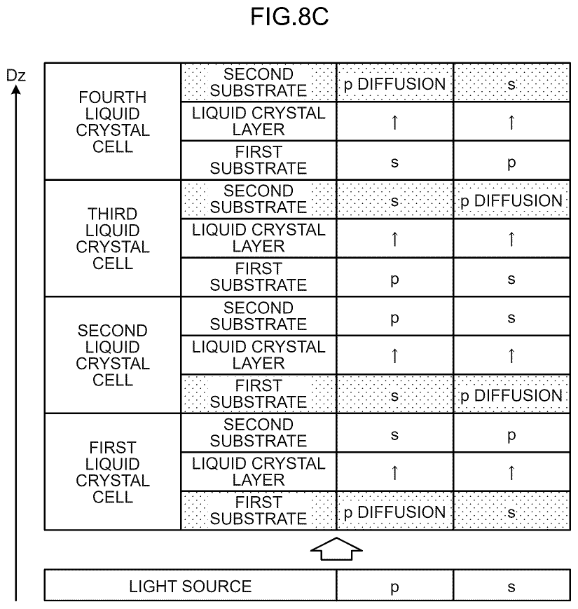

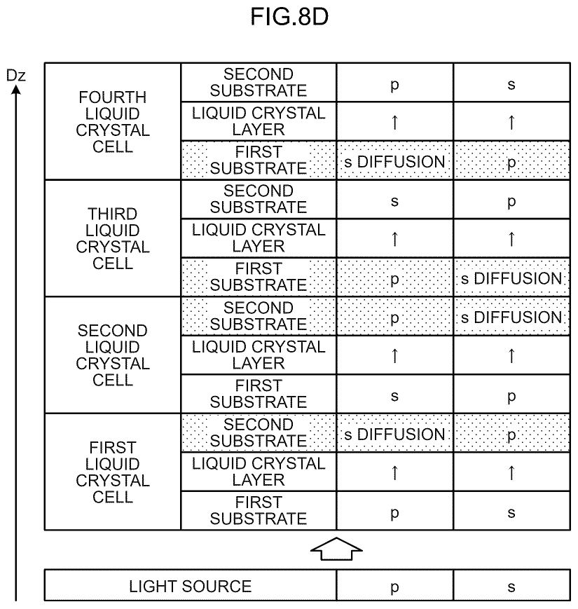

A mechanism for changing the shape of light by using the liquid crystal cells 2 (the first liquid crystal cell 2_1, the second liquid crystal cell 2_2, the third liquid crystal cell 2_3, and the fourth liquid crystal cell 2_4) will be described below. FIG. 7 is a multilayered structure diagram of the optical element 100 according to the embodiment. FIGS. 8A, 8B, 8C, and 8D are conceptual diagrams for description of change in shape of light by the optical element 100 according to the embodiment. FIGS. 8A, 8B, 8C, and 8D illustrate examples in which potential difference is generated between the drive electrodes of hatched substrates of the liquid crystal cells 2.

As illustrated in FIG. 7, the optical element 100 is provided on the optical axis of the light source 4, which is illustrated with a dashed and single-dotted line, and as described above, the first liquid crystal cell 2_1, the second liquid crystal cell 2_2, the third liquid crystal cell 2_3, and the fourth liquid crystal cell 2_4 are sequentially stacked from the light source 4 side (lower side in FIG. 7). The third liquid crystal cell 2_3 and the fourth liquid crystal cell 2_4 are stacked in a state of being rotated by 90° relative to the first liquid crystal cell 2_1 and the second liquid crystal cell 2_2.

In each liquid crystal cell 2, the alignment direction of the alignment film on the first substrate 5 side and the second substrate 6 side intersect each other as illustrated in FIGS. 6A and 6B. Accordingly, from the first substrate 5 side toward the second substrate 6 side, the orientation of the liquid crystal molecules in the liquid crystal layer 8 gradually changes from the Dx direction to the Dy direction (or from the Dy direction to the Dx direction), and the polarized light component of transmitted light rotates along with the change. Specifically, in the liquid crystal cell 2, the polarized light component, which is a p-polarized component on the first substrate 5 side, changes to an s-polarized light component as distance from the second substrate 6 decreases; and the polarized light component, which is an s-polarized light component on the first substrate 5 side, changes to a p-polarized component as distance from the second substrate 6 decreases. This rotation of the polarized light component may be referred to as optical rotation.

FIG. 8A illustrates a state in which no potential is generated between adjacent electrodes in each liquid crystal cell 2. In this case, only optical rotation occurs in each liquid crystal cell 2 and no polarized light component is diffused.

As illustrated in FIG. 8B, for example, when potential difference is generated between the drive electrodes 10a and 10b on the first substrate 5 in the first liquid crystal cell 2_1 to induce a horizontal electric field, the liquid crystal molecules between the electrodes are aligned in a circular arc shape, and thus, refractive index distribution is formed in the Dx direction in the liquid crystal layer 8. As light from the light source 4 is transmitted in this state, the above-described refractive index distribution acts on the polarized light component (in FIG. 8B, p-polarized component) parallel to the Dx direction, and therefore, the p-polarized component diffuses in the Dx direction.

In addition, when potential difference is generated between the drive electrodes 13a and 13b on the second substrate 6 side in the first liquid crystal cell 2_1, refractive index distribution is formed in the Dy direction on the second substrate 6 side, and accordingly, the s-polarized light component diffuses in the Dy direction on the second substrate 6 side. Specifically, the polarized light component having changed from a p-polarized component to an s-polarized light component during passing through the liquid crystal layer 8 in the first liquid crystal cell 2_1 diffuses in the Dy direction as well. However, the s-polarized light component at incidence on the first liquid crystal cell 2_1 optically rotates during passing through the liquid crystal layer 8 but intersects each refractive index distribution, and accordingly, only optically rotates without diffusing and passes through the first liquid crystal cell 2_1.

The s-polarized light component at incidence on the first liquid crystal cell 2_1 changes to a p-polarized component after passing through the first liquid crystal cell 2_1, and the second liquid crystal cell 2_2 acts on this p-polarized component. Specifically, as illustrated in FIGS. 8A and 8B, the first liquid crystal cell 2_1 acts on the p-polarized component of light incident on the optical element 100, and the second liquid crystal cell 2_2 acts on the s-polarized light component thereof. Since the third liquid crystal cell 2_3 and the fourth liquid crystal cell 2_4 are provided with rotation by 90° relative to the first liquid crystal cell 2_1 and the second liquid crystal cell 2_2, polarized light components on which they act are switched by 90°. Specifically, the third liquid crystal cell 2_3 acts on the s-polarized light component at incidence on the optical element 100, and the fourth liquid crystal cell 2_4 acts on the p-polarized component at incidence on the optical element 100.

As illustrated in FIG. 8C, in the optical element, it is possible to act on the p-polarized component by providing potential difference between drive electrodes extending in the Dy direction in each liquid crystal cell 2 (between the drive electrodes 10a and 10b of the first substrate 5 in the first liquid crystal cell 2_1 and the second liquid crystal cell 2_2 and between the drive electrodes 13a and 13b of the second substrate 6 in the third liquid crystal cell 2_3 and the fourth liquid crystal cell 2_4), thereby increasing the shape of light mainly in the Dx direction. This effect may be referred to as horizontal diffusion.

As illustrated in FIG. 8D, it is possible to act on the s-polarized light component by providing potential difference between drive electrodes extending in the Dx direction in each liquid crystal cell 2 (between the drive electrodes 13a and 13b of the second substrate 6 in the first liquid crystal cell 2_1 and the second liquid crystal cell 2_2 and between the drive electrodes 10a and 10b of the first substrate 5 in the third liquid crystal cell 2_3 and the fourth liquid crystal cell 2_4), thereby increasing the shape of light mainly in the Dy direction. This effect may be referred to as vertical diffusion.

The diffusion degree of light in each direction depends on the potential difference between the drive electrodes 10a and 10b (or between the drive electrodes 13a and 13b) adjacent to each other. The spread of light in the direction is maximum (100%) in a case where the potential difference between the drive electrodes 10a and 10b (or between the drive electrodes 13a and 13b) is maximum potential difference (for example, 30 V) defined in advance, and no spread of light (0%) occurs in the direction in a case where no potential difference is generated. Alternatively, the spread of light in the direction is 50% in a case where the potential difference between the drive electrodes 10a and 10b (or between the drive electrodes 13a and 13b) is 50% (for example, 15 V) of the above-described maximum potential difference. In a case where the relation between voltage difference and light spread is not linear, it is possible to set another potential difference instead of 15 V.

In each liquid crystal cell 2, the interval (also referred to as a cell gap) between its substrates (between the first substrate 5 and the second substrate 6) is large and is 10 μm to 50 μm approximately, more preferably 15 μm to 35 μm approximately, and thus, influence of an electric field formed in one of the substrates on the other substrate side is reduced as much as possible. Drive voltage that generates potential difference between the drive electrodes 10a and 10b (or between the drive electrodes 13a and 13b) adjacent to each other is what is called an alternating-current square wave, thereby preventing burn-in of the liquid crystal molecules.

The alignment directions of the alignment films, the extending directions of the drive electrodes on the substrates, and the angle between them may be modified as appropriate for the entire optical element 100 or each liquid crystal cell 2 in accordance with the characteristics of liquid crystals to be employed and optical characteristics to be intentionally obtained.

In the present embodiment, description is made on the configuration of the optical element 100 in which the four liquid crystal cells of the first liquid crystal cell 2_1, the second liquid crystal cell 2_2, the third liquid crystal cell 2_3, and the fourth liquid crystal cell 2_4 are stacked, but the optical element 100 is not limited to this configuration and may employ, for example, a configuration in which two or three liquid crystal cells 2 are stacked or a configuration in which a plurality of liquid crystal cells 2, five or more liquid crystal cells 2, are stacked.

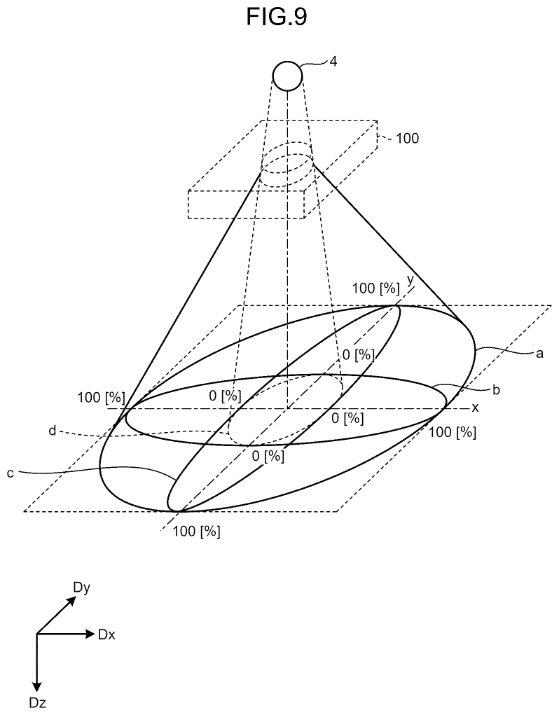

In the present disclosure, in the illumination device 1 with the above-described configuration, light incident on the optical element from the light source 4 is controlled in the two directions of the Dx direction (direction of horizontal diffusion) and the Dy direction (direction of vertical diffusion) by controlling drive voltage of each liquid crystal cell 2. The above-described vertical diffusion and horizontal diffusion may be collectively referred to as light diffusion. Accordingly, the shape of light emitted from the optical element is changed. The shape of light is a light shape that appears on a plane parallel to an emission surface of the optical element, and this may be referred to as a light distribution shape. The following describes control of the light diffusion degree in the present disclosure with reference to FIG. 9.

FIG. 9 is a conceptual diagram for conceptually describing control of the light diffusion degree of the illumination device 1 according to the embodiment. FIG. 9 illustrates an irradiation area of light on a virtual plane xy orthogonal to the Dz direction. The outline of the actual irradiation area is slightly unclear depending on the distance from the light source 4, a light diffraction phenomenon, and the like.

As described above, the drive voltage is supplied to the drive electrodes 10 and 13 of each liquid crystal cell 2 of the optical element 100 provided on the optical axis of the light source 4, whereby the alignment direction of the liquid crystal molecules 17 in the liquid crystal layer 8 is controlled. With this control, the light distribution shape of light emitted from the optical element 100 is controlled.

Specifically, for example, the light distribution shape in the Dx direction changes in accordance with the drive voltage applied to the drive electrodes 10 or drive electrodes 13 extending in the Dy direction in each liquid crystal cell 2 as described above (horizontal diffusion). The light distribution shape in the Dy direction changes in accordance with drive voltage applied to the drive electrodes 10 or the drive electrodes 13 extending in the Dx direction in the first to fourth liquid crystal cells (vertical diffusion).

In the present disclosure, the minimum diffusion degrees of the horizontal diffusion and the vertical diffusion are 0% and the maximum diffusion degrees thereof are 100%. More specifically, in a case where the horizontal diffusion degree is 0%, drive electrodes (for example, the drive electrodes 10 extending in the Dy direction on the first substrate 5 in the first liquid crystal cell 2_1) functioning to expand the light distribution state in the Dx direction do not act on the refractive index distribution of the liquid crystal layer 8. In this case, no potential difference is present between the adjacent drive electrodes 10a and 10b or no potential is supplied to the electrodes. On the other hand, in a case where the horizontal diffusion degree is 100%, drive electrodes (for example, the drive electrodes 10 extending in the Dy direction on the first substrate 5 in the first liquid crystal cell 2_1) functioning to expand the light distribution state in the Dx direction maximumly act on the refractive index distribution of the liquid crystal layer 8. In this case, the potential difference between the adjacent drive electrodes 10a and 10b is set to the maximum potential difference (for example, 30 V) in the optical element 100. In a case where the horizontal diffusion degree is larger than 0% and smaller than 100%, potential adjusted such that the potential difference between the adjacent drive electrodes 10a and 10b is larger than 0 V and smaller than the maximum potential difference (for example, 30 V) is applied to the electrodes. The same applies to the vertical diffusion.

Outline “a” illustrated in FIG. 9 exemplarily indicates the irradiation area in a case where the horizontal diffusion degree and the vertical diffusion degree are both 100%. Outline “b” illustrated in FIG. 9 exemplarily indicates the irradiation area in a case where the horizontal diffusion degree is 100% and the vertical diffusion degree is 0%. Outline “c” illustrated in FIG. 9 exemplarily indicates the irradiation area in a case where the horizontal diffusion degree is 0% and the vertical diffusion degree is 100%. Outline “d” illustrated in FIG. 9 exemplarily indicates the irradiation area in a case where the horizontal diffusion degree and the vertical diffusion degree are both 0%. In other words, outline “d” indicates the light distribution state when light from the light source 4 is emitted without being controlled by the optical element 100 (or simply transmitted through the optical element 100).

In this manner, in the illumination device 1 with the above-described configuration, it is possible to control the horizontal and vertical diffusion degrees of emission light from the optical element 100 by performing drive voltage control of each liquid crystal cell 2. Thus, it is possible to change the light distribution shape of emission light from the illumination device 1. Hereinafter, control that changes the light distribution shape of emission light from the illumination device 1 is also referred to as “light distribution control”.

In the present disclosure, the illumination device 1 capable of light distribution control in the two directions of the Dx and Dy directions is exemplarily described, but the controllable parameter of the illumination device 1 is not limited to light distribution (light spread). For example, the illumination device 1 may be capable of light adjustment control. In this case, the controllable parameters of the illumination device 1 may include light adjustment (brightness).

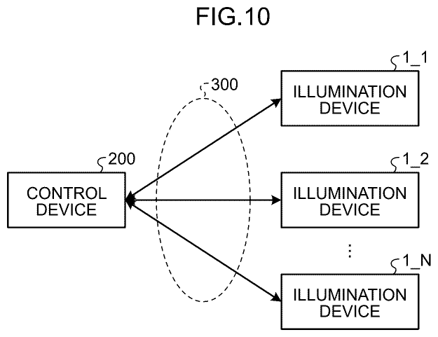

FIG. 10 is a schematic view illustrating an example of the configuration of an illumination system according to the embodiment. The illumination system according to the embodiment includes a plurality of illumination devices 1_1, 1_2, . . . , and 1_N and a control device 200. The control device 200 is, for example, a portable communication terminal device such as a smartphone or a tablet. The illumination devices 1_1, 1_2, . . . , and 1_N are each registered in the control device 200 in advance as a control target device having a light diffusion degree controllable by the control device 200.

Data and various command signals are transmitted bidirectionally between the control device 200 and each of the illumination devices 1_1, 1_2, . . . , and 1_N through a communication means 300. In the present disclosure, the communication means 300 is a wireless communication means of, for example, Bluetooth (registered trademark) or WiFi (registered trademark). Wireless communication may be performed between the control device 200 and each of the illumination devices 1_1, 1_2, . . . , and 1_N through, for example, a predetermined network such as a mobile communication network. Alternatively, each of the illumination devices 1_1, 1_2, . . . , and 1_N and the control device 200 may be coupled in a wired manner to perform wired communication therebetween.

As illustrated in FIG. 10, N (N is a natural number equal to or larger than one) illumination devices 1_n (n is a natural number of 1 to N) are control target devices of the control device 200 in the present disclosure, but the present disclosure is not limited by the number of control target devices (illumination devices 1_n) of the control device 200. Furthermore, in the present disclosure, an aspect in which the light diffusion degree of each illumination device 1_n is controlled as a setting parameter of a control target device (illumination device 1_n) will be described below, but the setting parameter is not limited to the light diffusion degree. Examples of setting parameters of a control target device (illumination device 1_n) may include the light quantity and color temperature of the illumination device 1_n.

In the present disclosure, it is sufficient that at least one illumination device 1 is registered as a control target device. Hereinafter, for sake of simplicity, processing between the control device 200 and one illumination device 1 will be described.

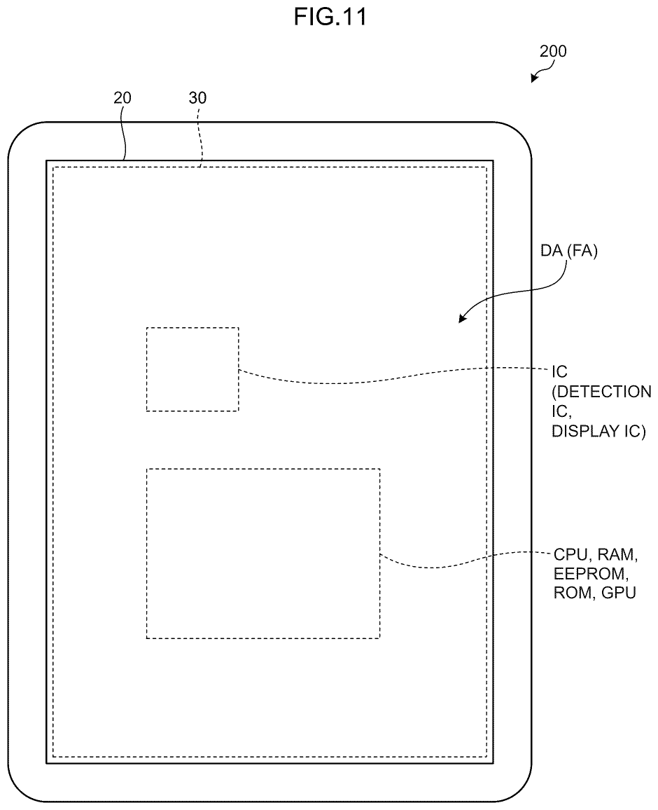

FIG. 11 is an exterior diagram illustrating an example of the control device 200 according to the embodiment. The control device 200 is a display device (touch screen) with a touch detection function in which a display panel 20 and a touch sensor 30 are integrated. The control device 200 includes, as internal constituent components, for example, various ICs such as a detection IC and a display IC, and a central processing unit (CPU), a random access memory (RAM), an electrically erasable programmable read only memory (EEPROM), a read only memory (ROM), and a graphics processing unit (GPU) of a smartphone, a tablet, or the like constituting the control device 200.

The display panel 20 is what is called an in-cell or hybrid device in which the touch sensor 30 is built and integrated. Building and integrating the touch sensor 30 in the display panel 20 includes, for example, sharing some members such as substrates and electrodes used as the display panel 20 and some members such as substrates and electrodes used as the touch sensor 30. Note that the display panel 20 may be what is called an on-cell type device in which the touch sensor 30 is mounted on a display device.

The display panel 20 is, for example, a liquid crystal display panel including a liquid crystal display element. The display panel 20 is not limited thereto but may be, for example, an organic EL display panel (organic light emitting diode (OLED)) or an inorganic EL display panel (micro LED or mini LED).

The touch sensor 30 is, for example, a capacitive touch sensor. The touch sensor 30 is not limited thereto but may be, for example, a touch sensor of a resistance film scheme or a touch sensor of an ultrasonic wave scheme or an optical scheme.

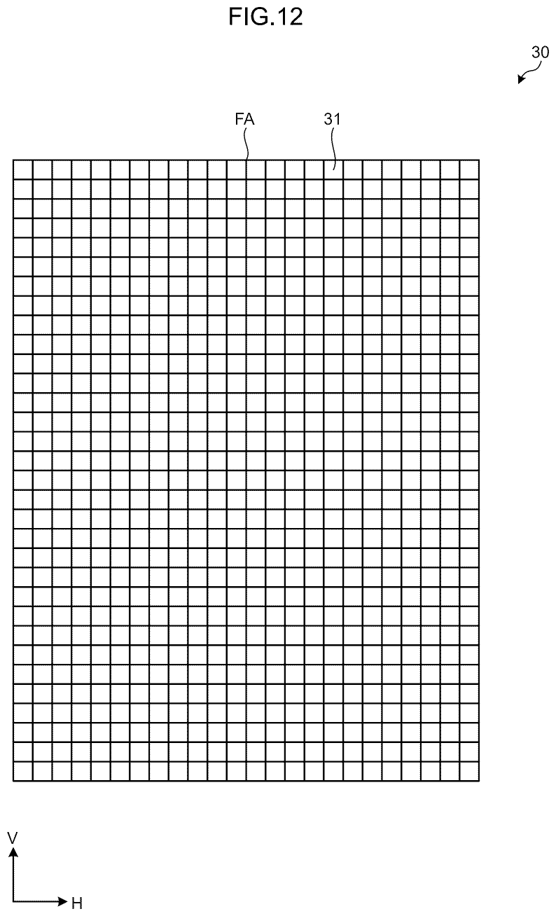

FIG. 12 is a conceptual diagram illustrating an example of a touch detection region of the touch sensor 30. A plurality of detection elements 31 are provided in a detection region FA of the touch sensor 30. The detection elements 31 in the detection region FA of the touch sensor 30 are arranged in an X direction and a Y direction orthogonal to the X direction and provided in a matrix of a row-column configuration. In other words, the touch sensor 30 has the detection region FA overlapping the detection elements 31 arranged in the X direction and the Y direction.

Basic configurations and operation for controlling the light diffusion degree of the illumination device 1 in the above-described configuration of the illumination system according to the embodiment will be described below.

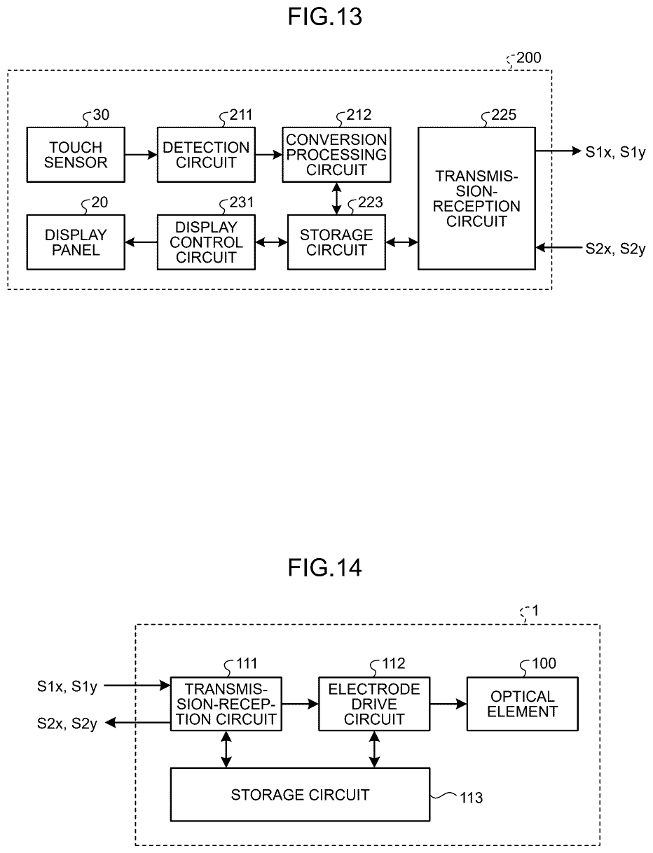

FIG. 13 is a diagram illustrating an example of a control block configuration of the control device 200 according to the embodiment. The following describes, first, a control block configuration for executing each processing to be described later.

As illustrated in FIG. 13, the control device 200 according to the embodiment includes the display panel 20, the touch sensor 30, a detection circuit 211, a conversion processing circuit 212, a storage circuit (first storage circuit) 223, a transmission-reception circuit 225, and a display control circuit 231. The detection circuit 211 is configured with, for example, a detection IC.

Alternatively, the detection circuit 211 and the display control circuit 231 may be mounted as one display IC on the display panel 20 or on an FPC coupled to the display panel 20. The conversion processing circuit 212 and the storage circuit 223 are each configured with, for example, the CPU, RAM, EEPROM, and ROM of a smartphone, a tablet, or the like constituting the control device 200. The display control circuit 231 may be a display IC mounted on the display panel 20 as described above, and moreover, may include, for example, the GPU of a smartphone, a tablet, or the like constituting the control device 200. The transmission-reception circuit 225 is configured with, for example, a wireless communication module of a smartphone, a tablet, or the like constituting the control device 200.

The detection circuit 211 is a circuit that detects existence of a touch on the touch sensor 30 based on a detection signal output from each detection element 31 of the touch sensor 30.

The conversion processing circuit 212 is a circuit that executes conversion processing of the position of touch detection by the detection circuit 211 into various setting values (in the present disclosure, light diffusion degrees) of the illumination device 1. In the present disclosure, the conversion processing circuit 212 has a function to execute conversion processing of the position of touch detection by the detection circuit 211, that is, a touched object (pictorial image) into operation states on various screens. The conversion processing circuit 212 is a component achieved by, for example, the CPU of a smartphone, a tablet, or the like constituting the control device 200.

The storage circuit 223 is configured with, for example, the RAM, EEPROM, and ROM of a smartphone, a tablet, or the like constituting the control device 200. In the present disclosure, the storage circuit 223 stores setting information including various setting values (in the present disclosure, light diffusion degrees) of the illumination device 1. The storage circuit 223 temporarily stores, for example, intermediate data in each processing to be described later.

The setting information is transmitted bidirectionally between the transmission-reception circuit 225 and the illumination device 1. Specifically, the transmission-reception circuit 225 transmits a Dx-directional light diffusion degree S1x and a Dy-directional light diffusion degree Sly to the illumination device 1 as first setting information in each processing to be described later. The transmission-reception circuit 225 receives second light diffusion degree information (a Dx-directional light diffusion degree S2x and a Dy-directional light diffusion degree S2y) transmitted from the illumination device 1.

The display control circuit 231 executes display control processing for displaying a coarse adjustment mode screen or a fine adjustment mode screen to be described later on the display panel 20. The display control circuit 231 in the present disclosure performs display control of the display panel 20 based on various kinds of setting information stored in a storage region of the storage circuit 223 and position information of pictorial images.

FIG. 14 is a diagram illustrating an example of a control block configuration of the illumination device 1 according to the embodiment. As illustrated in FIG. 14, the illumination device 1 according to the embodiment includes a transmission-reception circuit 111, an electrode drive circuit 112, and a storage circuit (second storage circuit) 113 as control blocks for controlling the optical element 100 described above.

The transmission-reception circuit 111 transmits and receives the light diffusion degree information to and from the control device 200. Specifically, the transmission-reception circuit 111 receives the first light diffusion degree information (the Dx-directional light diffusion degree S1x and the Dy-directional light diffusion degree S1y) transmitted from the control device 200. The transmission-reception circuit 111 transmits, to the control device 200, the Dx-directional light diffusion degree S2x and the Dy-directional light diffusion degree S2y stored in the storage circuit 113 as the second light diffusion degree information.

In the present disclosure, upon activation of the illumination device 1, the transmission-reception circuit 111 transmits, to the control device 200, the Dx-directional light diffusion degree S2x and the Dy-directional light diffusion degree S2y stored in the storage circuit 113 as the second light diffusion degree information and stores, in the storage circuit 113 as the new Dx-directional light diffusion degree S2x and the new Dy-directional light diffusion degree S2y, the first light diffusion degree information (the Dx-directional light diffusion degree S1x and the Dy-directional light diffusion degree S1y) transmitted from the control device 200 by each processing of the control device 200 to be described later. In other words, when the first light diffusion degree information is transmitted from the control device 200 to the illumination device 1, the second light diffusion degree information is updated to the first light diffusion degree information. The illumination device 1 initially does not store the second light diffusion degree information (0% for the vertical diffusion and the horizontal diffusion). In this case, as the first light diffusion degree information is transmitted from the control device 200, whereby the second light diffusion degree information is stored.

The electrode drive circuit 112 supplies drive voltage in accordance with the Dx-directional light diffusion degree S2x and the Dy-directional light diffusion degree S2y stored in the storage circuit 113 to the drive electrodes 10 and 13 of each liquid crystal cell 2 of the optical element 100.

Specifically, upon activation of the illumination device 1, the electrode drive circuit 112 supplies drive voltage corresponding to the second setting information stored in the storage circuit 113 to the drive electrodes 10 and 13 of each liquid crystal cell 2 of the optical element 100.

The electrode drive circuit 112 also supplies, to the drive electrodes 10 and 13 of each liquid crystal cell 2 of the optical element 100, drive voltage corresponding to the second setting information updated based on the first setting information transmitted from the control device 200.

The storage circuit 113 is composed of, for example, a RAM, an EEPROM, or a ROM. In the present disclosure, the storage circuit 113 stores the final value of the second setting information in a previous operation of the illumination device 1.

Processing of the illumination system in the present disclosure is executed by application software (hereinafter also referred to as “illumination control application”) operating on the control device 200. The illumination control application in the present disclosure has a coarse adjustment mode (first adjustment mode) and a fine adjustment mode (second adjustment mode). The coarse adjustment mode (first adjustment mode) is a mode in which various setting values (in the present disclosure, light diffusion degree) of the illumination device 1 are adjusted with a coarse (wide) step (first adjustment step) (hereinafter also referred to as “coarse adjustment”). The fine adjustment mode (second adjustment mode) is a mode in which the setting values are adjusted with a finer (narrower) step (second adjustment step) than that in the coarse adjustment mode (hereinafter also referred to as “fine adjustment”). The following describes specific examples of processing and display aspects of the illumination control application in detail.

### First Embodiment

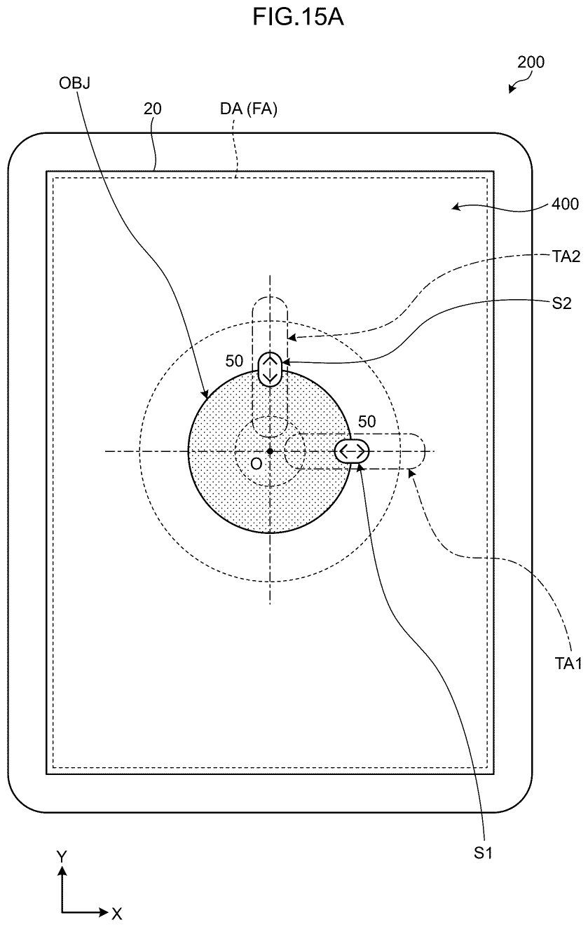

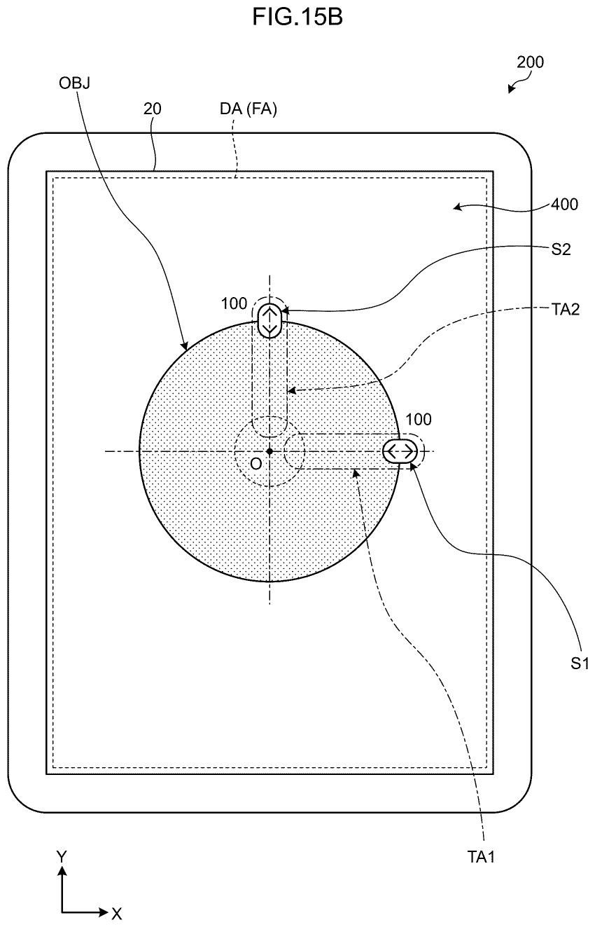

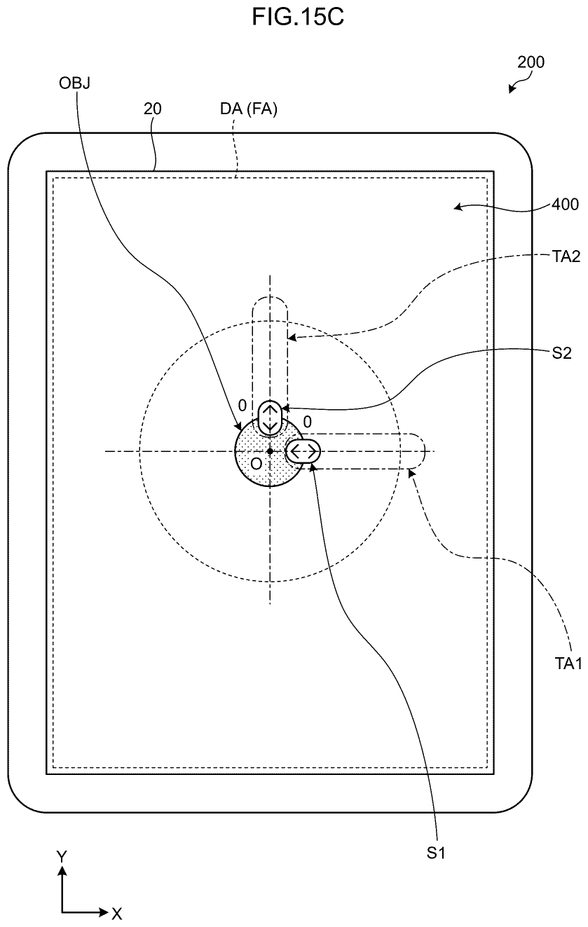

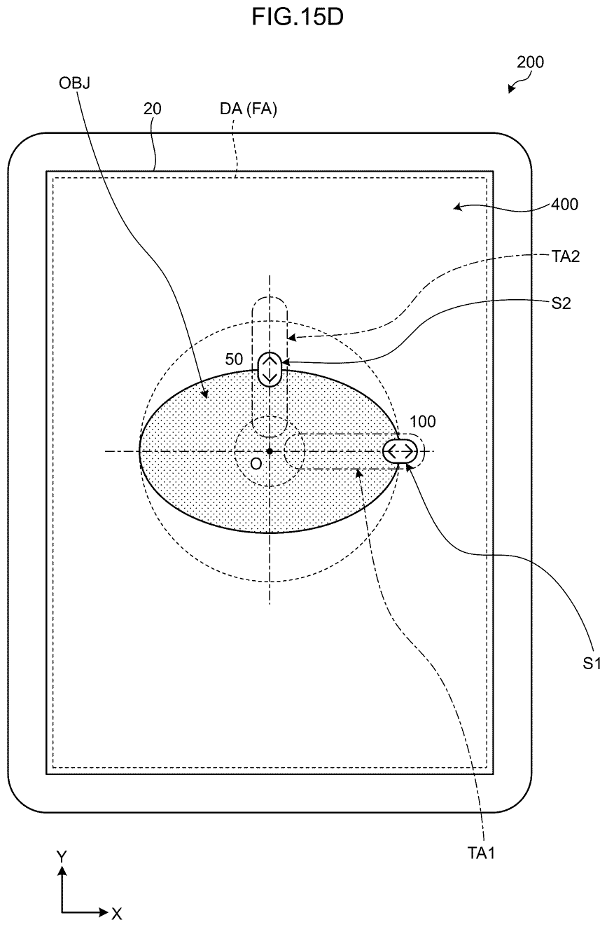

FIGS. 15A, 15B, 15C, and 15D are conceptual diagrams illustrating an example of the display aspect of the coarse adjustment mode screen on the control device according to a first embodiment.

In description of the present disclosure, it is assumed that the illumination control application is installed on the control device 200 in advance.

When the illumination control application is activated, a coarse adjustment mode screen 400 illustrated in FIGS. 15A, 15B, 15C, and 15D is displayed and pairing processing is executed between the control device 200 and the illumination device 1 registered as a control target device of the control device 200 in advance. A pairing button (not illustrated) may be displayed on the coarse adjustment mode screen 400, and pairing processing may be executed between the control device 200 and the illumination device 1 when the pairing button is touched by a user. At initial activation of the illumination control application, for example, the illumination device 1 activated in a space where pairing is possible may be registered as a control target device.

On the coarse adjustment mode screen 400 illustrated in FIGS. 15A, 15B, 15C, and 15D, the X direction is defined as the Dx direction (first direction) in light diffusion degree control of the illumination device 1, and the Y direction is defined as the Dy direction (second direction) in light diffusion degree control of the illumination device 1. An XY plane with an origin O(0, 0) at a predetermined position in a display region DA is defined on the coarse adjustment mode screen 400.

The display panel 20 is provided with the display region DA overlapping the detection region FA of the touch sensor 30 in a plan view. In the example illustrated in FIGS. 15A, 15B, 15C, and 15D, a light distribution shape object OBJ with a center point at the origin O(0, 0) of the XY plane on the coarse adjustment mode screen 400 is displayed, and a first slider S1 and a second slider S2 for setting the light diffusion degree of the illumination device 1 are disposed on the outline of the light distribution shape object OBJ.

The light distribution shape object OBJ is a pictorial image on the coarse adjustment mode screen 400, corresponding to the light distribution state of light emitted from the illumination device 1.

The first slider S1 and the second slider S2 are, for example, pictorial images displayed on the coarse adjustment mode screen 400, which a user can touch and move (drag operation) with a finger.

The shape of the light distribution shape object OBJ can be changed by moving the first slider S1 in the X direction. Simultaneously, the light diffusion degree (horizontal diffusion degree) of the illumination device 1 in the Dx direction is controlled. The shape of the light distribution shape object OBJ can be changed by moving the second slider S2 in the Y direction. Simultaneously, the light diffusion degree (vertical diffusion degree) of the illumination device 1 in the Dy direction is controlled.

FIG. 15A illustrates an example in which the illumination device 1 has a Dx-directional light diffusion degree Sx of 50% and a Dy-directional light diffusion degree Sy of 50%. As illustrated in FIG. 15A, the values of the Dx-directional light diffusion degree Sx and the Dy-directional light diffusion degree Sy are displayed on the coarse adjustment mode screen as well. In the following description, the Dx-directional light diffusion degree Sx is referred to as a horizontal diffusion degree Sx, and the Dy-directional light diffusion degree Sy is referred to as a vertical diffusion degree Sy. FIG. 15B illustrates an example in which the horizontal diffusion degree Sx of the illumination device 1 is 100% and the vertical diffusion degree Sy thereof is 100%. FIG. 15C illustrates an example in which the horizontal diffusion degree Sx of the illumination device 1 is 0% and the vertical diffusion degree Sy thereof is 0%. FIG. 15D illustrates an example in which the horizontal diffusion degree Sx of the illumination device 1 is 100% and the vertical diffusion degree Sy thereof is 50%.

In the present disclosure, the shape of the light distribution shape object OBJ on the coarse adjustment mode screen 400 changes in a circular or elliptical shape along with movement of the first slider S1 and the second slider S2 as illustrated in FIGS. 15A, 15B, 15C, and 15D.

As illustrated in FIG. 9, in the illumination device 1 as a control target in the present disclosure, a predetermined substantially circular area (outline “d”) is irradiated with light even in a case where the horizontal diffusion degree Sx and vertical diffusion degree Sy of the illumination device 1 are both 0%. In the present disclosure, as illustrated in FIG. 15C, the light distribution shape object OBJ in a small circular shape is displayed in a case where the horizontal diffusion degree Sx and the vertical diffusion degree Sy are both 0%.

In the present disclosure, as illustrated in FIGS. 15A, 15B, 15C, and 15D, a first adjustment region TAL is provided as a region in which the touch detection position in the X direction can be acquired. The first adjustment region TAL is set as a region where the light distribution shape in the X direction is adjustable in the entire range of a minimum value (0%) to a maximum value (100%) in the coarse adjustment mode (first adjustment mode).

In the present disclosure, the scale of one step in the first adjustment region TA1 in the fine adjustment mode (second adjustment mode) is equal to the scale of one step in the first adjustment region TA1 in the coarse adjustment mode (first adjustment mode). In other words, in the first adjustment region TA1, the movement amount of the touch detection position in the X direction when a change by one step is made in the fine adjustment mode (second adjustment mode) is equal to the movement amount of the touch detection position in the X direction when a change by one step is made in the coarse adjustment mode (first adjustment mode).

In the coarse adjustment mode, the first slider S1 can be moved in the X direction in the first adjustment region TA1 between the position on the outline of the light distribution shape object OBJ in a case where the horizontal diffusion degree Sx is 0% and the position on the outline of the light distribution shape object OBJ in a case where the horizontal diffusion degree Sx is 100%. Accordingly, the first slider S1 does not move when the user's finger moves away from the screen or even when it remains on the screen but moves out of the first adjustment region TA1.

In addition, in the present disclosure, as illustrated in FIGS. 15A, 15B, 15C, and 15D, a second adjustment region TA2 is provided as a region in which the touch detection position in the Y direction can be acquired. The second adjustment region TA2 is set as a region where the light distribution shape in the Y direction is adjustable in the entire range of a minimum value (0%) to a maximum value (100%) in the coarse adjustment mode (first adjustment mode).

In the present disclosure, the scale of one step in the second adjustment region TA2 in the fine adjustment mode (second adjustment mode) is equal to the scale of one step in the second adjustment region TA2 in the coarse adjustment mode (first adjustment mode). In other words, in the second adjustment region TA2, the movement amount of the touch detection position in the Y direction when a change by one step is made in the fine adjustment mode (second adjustment mode) is equal to the movement amount of the touch detection position in the Y direction when a change by one step is made in the coarse adjustment mode (first adjustment mode).

In the coarse adjustment mode, the second slider S2 can be moved in the Y direction in the second adjustment region TA2 between the position on the outline of the light distribution shape object OBJ in a case where the vertical diffusion degree Sy is 0% and the position on the outline of the light distribution shape object OBJ in a case where the vertical diffusion degree Sy is 100%. Accordingly, the second slider S2 does not move when the user's finger moves away from the screen or even when it remains on the screen but moves out of the second adjustment region TA2.

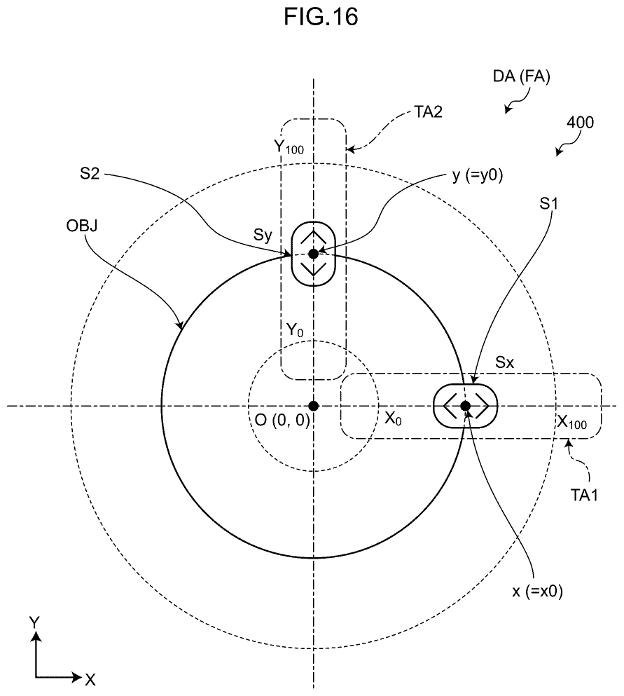

FIG. 16 is a diagram for description of the relation between the position on the illumination control application on the control device 200 according to the first embodiment and the light diffusion degree. In the present disclosure, to facilitate description, the position (coordinate) in the display region DA of the display panel 20 and the position (coordinate) on the detection region FA of the touch sensor 30 are assumed to be equivalent.

On the coarse adjustment mode screen 400 of the control device 200 according to the first embodiment, the horizontal diffusion degree Sx of the illumination device 1 can be set based on the movement amount of a position x of an intersection point of the X axis of the XY plane and the outline of the light distribution shape object OBJ.

In the present disclosure, the position x of the intersection point of the X axis and the outline of the light distribution shape object OBJ is the center point of the first slider S1. In other words, a position x0 of the first slider S1 in the display region DA coincides with the position x of the intersection point of the X axis and the outline of the light distribution shape object OBJ. Accordingly, the horizontal diffusion degree Sx of the illumination device 1 can be set by touching the first slider S1 and moving the first slider S1 in the X-axis direction. In FIG. 16, “Sx” displayed near the first slider S1 indicates the horizontal diffusion degree (for example, “50” %) of the illumination device 1.

The reference movement amount Px in the X direction on the XY plane in a case where a horizontal diffusion degree change amount ΔSx of the illumination device 1 is 1% is expressed by Expression (1) below, where X₁₀₀ represents the intersection point of the X axis and the outline of the light distribution shape object OBJ in a case where the horizontal diffusion degree Sx is 100%, and X₀ represents the intersection point of the X axis and the outline of the light distribution shape object OBJ in a case where the horizontal diffusion degree Sx is 0%.

$$Px = ( {X}_{100} - {X}_{0} ) / 100 \qquad ( 1 )$$

The relation between the horizontal diffusion degree Sx and the position x0 of the first slider S1 in the display region DA on the XY plane is expressed by Expressions (2) and (3) below by using Expression (1) described above.

$$Sx = ( x 0 - {X}_{0} ) / Px \qquad ( 2 )$$

$$x 0 = Sx \times Px + {X}_{0} \qquad ( 3 )$$

On the coarse adjustment mode screen 400 of the control device 200 according to the first embodiment, the vertical diffusion degree Sy of the illumination device 1 can be set based on the movement amount of a position y of an intersection point of the Y axis of the XY plane and the outline of the light distribution shape object OBJ.

In the present disclosure, the position y of the intersection point of the Y axis and the outline of the light distribution shape object OBJ is the center point of the second slider S2. In other words, a position y0 of the second slider S2 in the display region DA coincides with the position y of the intersection point of the Y axis and the outline of the light distribution shape object OBJ. Accordingly, the vertical diffusion degree Sy of the illumination device 1 can be set by touching the second slider S2 and moving the second slider S2 in the Y-axis direction. In FIG. 16, “Sy” displayed near the first slider S2 indicates the vertical diffusion degree (for example, “50” %) of the illumination device 2.

The reference movement amount Py in the Y direction on the XY plane in a case where a vertical diffusion degree change amount ΔSy of the illumination device 1 is 1% is expressed by Expression (4) below, where Y₁₀₀ represents the intersection point of the Y axis and the outline of the light distribution shape object OBJ in a case where the vertical diffusion degree Sy is 100%, and Y₀ represents the intersection point of the Y axis and the outline of the light distribution shape object OBJ in a case where the vertical diffusion degree Sy is 0%.

$$Py = ( {Y}_{100} - {Y}_{0} ) / 100 \qquad ( 4 )$$

The relation between the vertical diffusion degree Sy and the position y0 of the second slider S2 in the display region DA on the XY plane is expressed by Expressions (5) and (6) below by using Expression (4) described above.

$$Sy = ( y 0 - {Y}_{0} ) / Py \qquad ( 5 )$$

$$y 0 = Sy \times Py + {Y}_{0} \qquad ( 6 )$$

The above description is made on the aspect in which the light distribution shape object OBJ in a circular shape is displayed in a case where the horizontal diffusion degree Sx and the vertical diffusion degree Sy are both 0%, but the present disclosure is not limited thereto. For example, the origin O(0, 0) of the XY plane on the coarse adjustment mode screen 400 may be a position in a case where the horizontal diffusion degree Sx and the vertical diffusion degree Sy are both 0%.

When having detected a long press state of the first slider S1 or the second slider S2 on the coarse adjustment mode screen 400 described above, the control device 200 transitions from the coarse adjustment mode (first adjustment mode) to the fine adjustment mode (second adjustment mode).

In the present disclosure, the “long press state of the first slider S1” refers to a state in which a time T1 during which the movement amount Δx of the first slider S1 on the coarse adjustment mode screen 400 remains equal to or smaller than a movement amount threshold Δxth is equal to or longer than a predetermined long-press detection time (first time threshold) T1th (for example, 2 sec), wherein the movement amount Δx of the first slider S1 refers to the movement amount of the touch detection position in the X direction, and the movement amount threshold Δxth refers to the horizontal diffusion degree change amount ΔSx=1% (first adjustment step).

In the present disclosure, the “long press state of the second slider S2” refers to a state in which a time T1 during which the movement amount Δy of the second slider S2 on the coarse adjustment mode screen 400 remains equal to or smaller than a movement amount threshold Δyth is equal to or longer than the predetermined long-press detection time (first time threshold) T1th (for example, 2 sec), wherein the movement amount Δy of the second slider S2 refers to the movement amount of the touch detection position in the Y direction, and the movement amount threshold Δyth refers to the vertical diffusion degree change amount ΔSy=1% (first adjustment step).

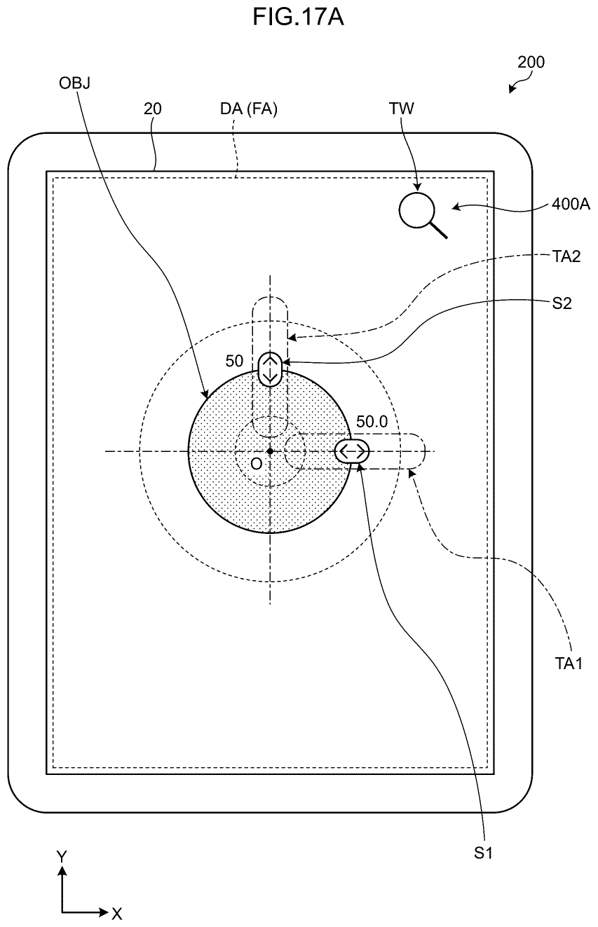

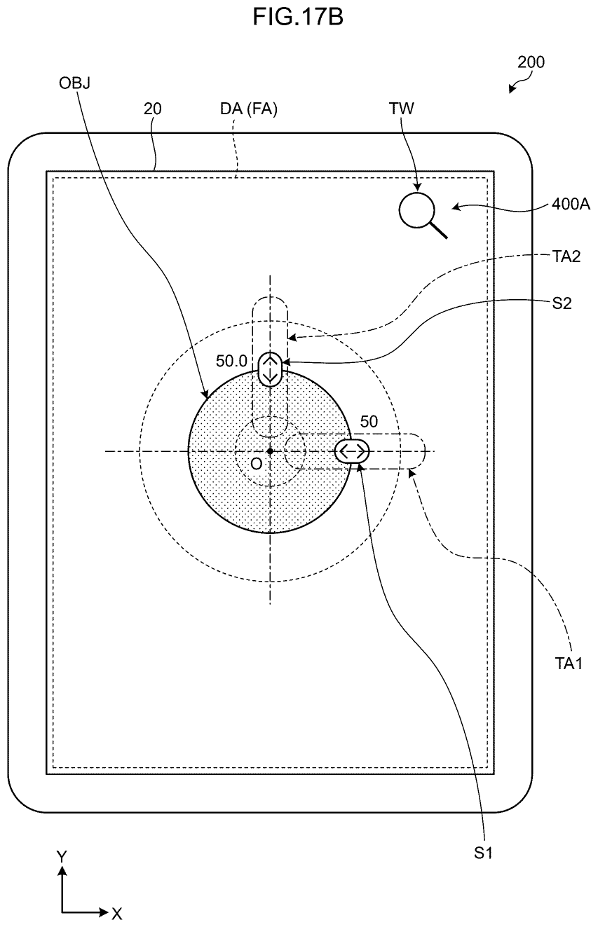

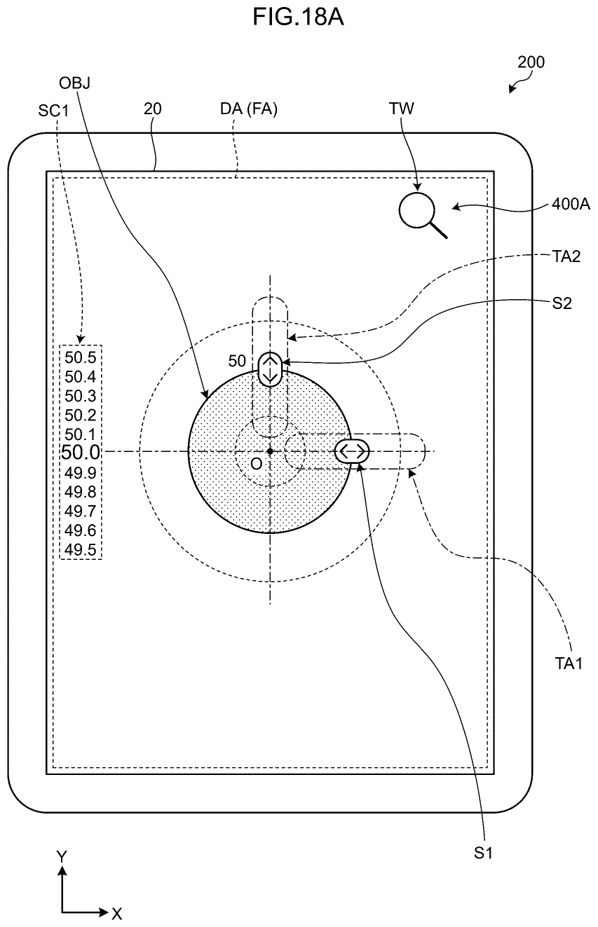

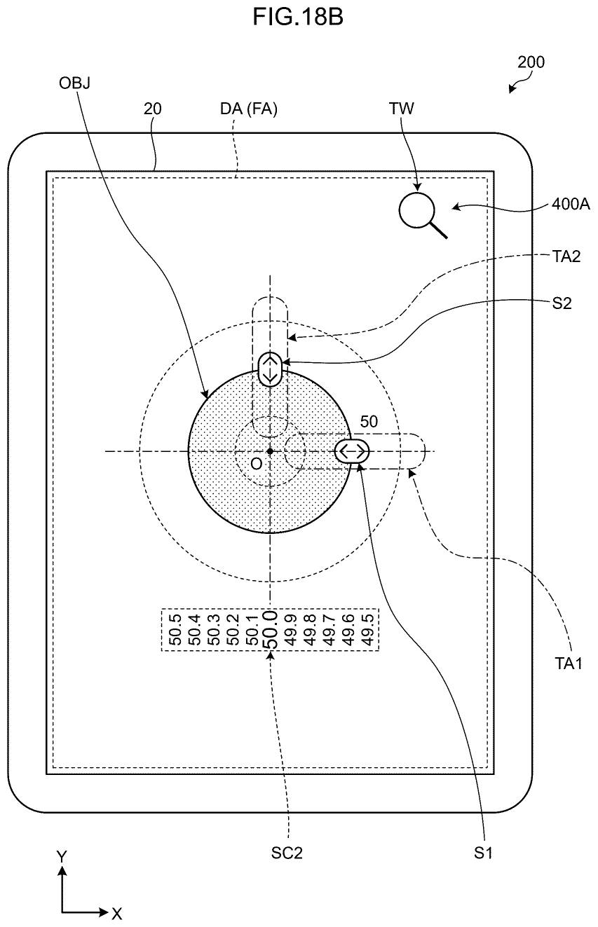

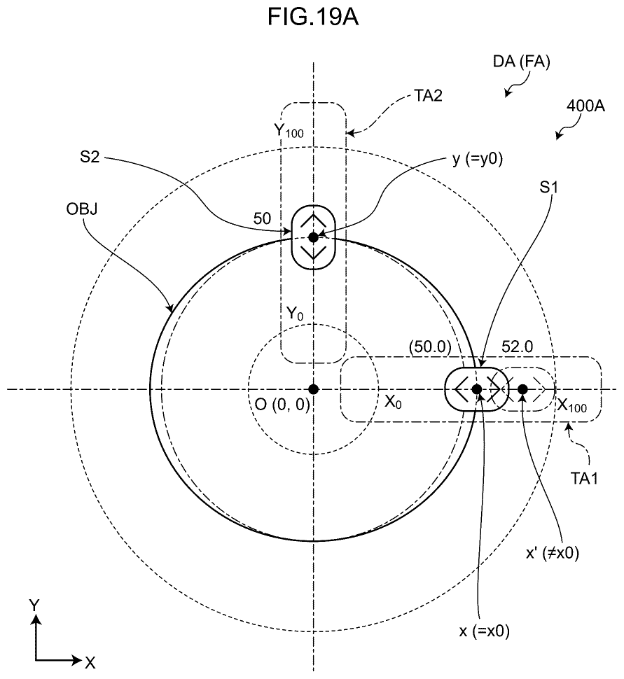

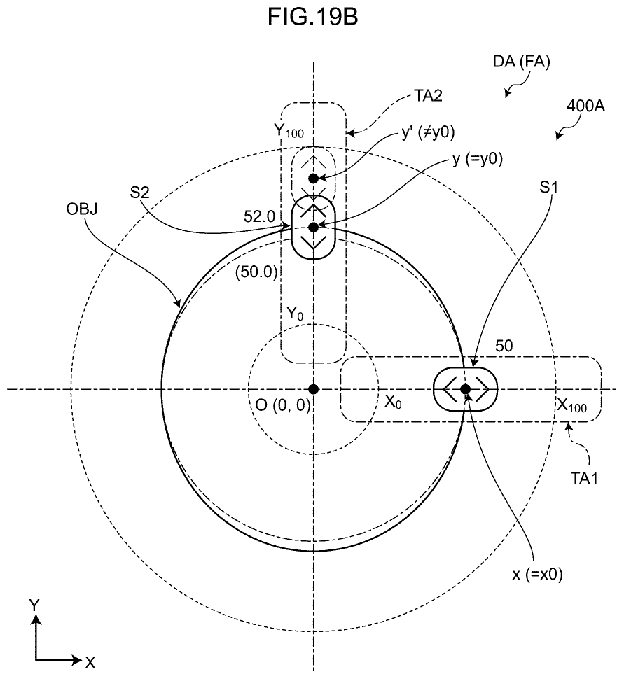

FIGS. 17A and 17B are conceptual diagrams illustrating a first example of the display aspect of the fine adjustment mode screen on the control device according to the first embodiment. FIGS. 18A and 18B are conceptual diagrams illustrating a second example of the display aspect of the fine adjustment mode screen on the control device according to the first embodiment. FIG. 19A is a first diagram for description of the relation between the position on the fine adjustment mode screen on the control device according to the first embodiment and the light diffusion degree. FIG. 19B is a second diagram for description of the relation between the position on the fine adjustment mode screen on the control device according to the first embodiment and the light diffusion degree.

When having detected the long press state of the first slider S1, the control device 200 transitions from the coarse adjustment mode to the fine adjustment mode and displays a fine adjustment mode screen 400A illustrated in FIG. 17A or 18A. On the fine adjustment mode screen 400A, a fine adjustment mode icon TW is displayed on the coarse adjustment mode screen 400. The fine adjustment mode icon TW is a pictorial image indicating that the current adjustment mode is the fine adjustment mode.

FIG. 17A exemplarily illustrates an aspect in which the horizontal diffusion degree Sx (for example, “50.0” %) of the illumination device 1 is displayed near the first slider S1. FIG. 18A exemplarily illustrates an aspect in which a scale display region SC1 including the horizontal diffusion degree Sx (for example, “50.0” %) of the illumination device 1 is displayed at an arbitrary position in the display region DA. The aspect of displaying the horizontal diffusion degree Sx of the illumination device 1 in the fine adjustment mode of the horizontal diffusion degree Sx may be the aspect of the first example illustrated in FIG. 17A or the aspect of the second example illustrated in FIG. 18A.

FIG. 17B exemplarily illustrates an aspect in which the vertical diffusion degree Sy (for example, “50.0” %) of the illumination device 1 is displayed near the second slider S2. FIG. 18B exemplarily illustrates an aspect in which a scale display region SC2 including the vertical diffusion degree Sy (for example, “50.0” %) of the illumination device 1 is displayed at an arbitrary position in the display region DA. The aspect of displaying the vertical diffusion degree Sy of the illumination device 1 in the fine adjustment mode of the vertical diffusion degree Sy may be the aspect of the first example illustrated in FIG. 17B or the aspect of the second example illustrated in FIG. 18B.

In the fine adjustment mode, adjustment steps are different from those in the coarse adjustment mode. Specifically, when the adjustment steps (first adjustment steps) of the coarse adjustment mode are 1%, the adjustment steps (second adjustment steps) of the fine adjustment mode are set to, for example, 0.1%; wherein the adjustment steps (first adjustment steps) of the coarse adjustment mode are adjustment steps (first adjustment steps) ΔSxmin and ΔSymin (that is, the minimum value of the horizontal diffusion degree change amount ΔSx and the minimum value of the vertical diffusion degree change amount ΔSy) in the coarse adjustment mode; and the adjustment steps (second adjustment steps) of the fine adjustment mode are a minimum value ΔSxTWmin of a horizontal diffusion degree change amount ΔSxTW and a minimum value ΔSyTWmin of a vertical diffusion degree change amount ΔSyTW in the fine adjustment mode. In this case, the movement amount of the touch detection position corresponding to 1% in the coarse adjustment mode corresponds to 0.1% in the fine adjustment mode.

Thus, as illustrated in FIG. 19A, for example, when the horizontal diffusion degree Sx is set to 52.0% in the fine adjustment mode, the position x0 of the first slider S1 in the display region DA, which is the position x of the intersection point of the X axis and the outline of the light distribution shape object OBJ, is different from a touch detection position x′ in the X direction (x′≠x0). More specifically, the apparent movement amount of the touch detection position x′ in the X direction when the horizontal diffusion degree Sx is changed from 50.0% illustrated with a dashed and single-dotted line to 52.0% illustrated with a solid line in the fine adjustment mode corresponds to 20%, which is 10 times larger than the actual horizontal diffusion degree change amount ΔSx=2.0%.

As illustrated in FIG. 19B, for example, when the vertical diffusion degree Sy is set to 52.0% in the fine adjustment mode, the position y0 of the second slider S2 in the display region DA, which is the position y of the intersection point of the Y axis and the outline of the light distribution shape object OBJ, is different from a touch detection position y′ in the Y direction (y′≠y0). More specifically, the apparent movement amount of the touch detection position y′ in the Y direction when the vertical diffusion degree Sy is changed from 50.0% illustrated with a dashed and single-dotted line to 52.0% illustrated with a solid line in the fine adjustment mode corresponds to 20%, which is 10 times larger than the actual vertical diffusion degree change amount ΔSy=2.0%.

The adjustment steps (first adjustment steps) ΔSxmin and ΔSymin in the coarse adjustment mode (first adjustment mode) are not limited to 1%. The adjustment steps (second adjustment steps) ΔSxTWmin and ΔSyTWmin in the fine adjustment mode (second adjustment mode) are not limited to 0.1%. The adjustment steps (second adjustment steps) in the fine adjustment mode (second adjustment mode) only need to have the amounts of change smaller than those of the adjustment steps (first adjustment steps) in the coarse adjustment mode (first adjustment mode), and the present disclosure is not limited to specific values (amounts of change) of the adjustment steps (first adjustment steps) in the coarse adjustment mode and the adjustment steps (second adjustment steps) in the fine adjustment mode.

The following describes specific examples of processing by the control device 200 for the illumination device 1 according to the first embodiment described above.

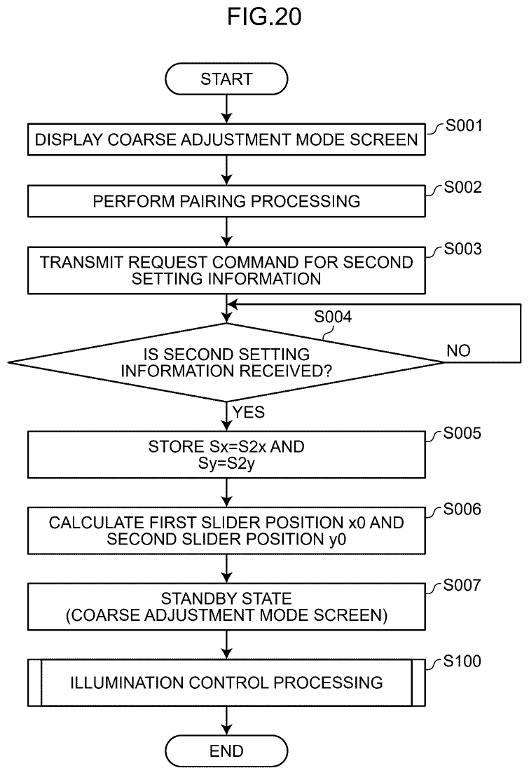

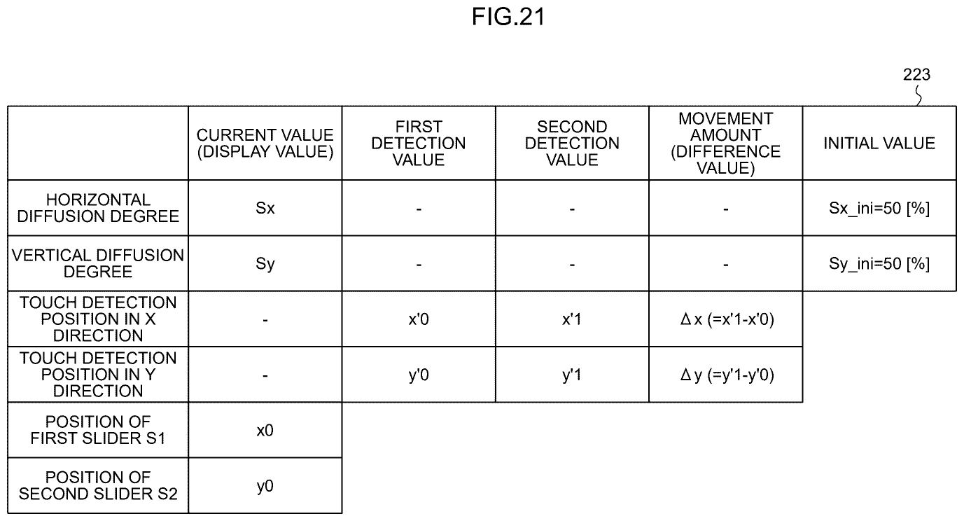

Processing during execution of the above-described illumination control application is achieved by application software executed by, for example, the CPU of a smartphone, a tablet, or the like constituting the control device 200. FIG. 20 is a flowchart illustrating an example of initial setting processing by the control device 200 for the illumination device 1 according to the first embodiment. FIG. 21 is a conceptual diagram illustrating an example of a storage region in the control device 200 for the illumination device 1 according to the first embodiment.

When the illumination control application is activated on the control device 200, the coarse adjustment mode screen of the illumination control application illustrated in FIGS. 15A, 15B, 15C, and 15D is displayed in the display region DA (step S001).

Before activation of the illumination control application, the illumination device 1 registered in advance in a space where pairing with the control device 200 is possible, is activated.

The transmission-reception circuit 225 of the control device 200 executes pairing processing with the illumination device 1 registered as a control target device in advance and activated in a space where pairing with the control device 200 is possible (step S002), and transmits a request command for the second setting information to the control target device (illumination device 1) (step S003).

The transmission-reception circuit 111 of the illumination device 1 reads the second setting information stored in the storage circuit 113 and transmits the second setting information to the control device 200. The electrode drive circuit 112 of the illumination device 1 supplies drive voltage corresponding to the second setting information to the drive electrodes 10 and 13 of each liquid crystal cell 2 of the optical element 100.

The transmission-reception circuit 225 of the control device 200 determines whether the second setting information is received from the illumination device 1 (step S004). If the second setting information is not received from the illumination device 1 (No at step S004), the processing at step S004 is repeatedly executed.

If the second setting information is received from the illumination device 1 (Yes at step S004), the transmission-reception circuit 225 stores, in the storage region of the storage circuit 223 illustrated in FIG. 21, the Dx-directional light diffusion degree S2x in the second setting information of the illumination device 1 as the current display value of the horizontal diffusion degree Sx, and the Dy-directional light diffusion degree S2y therein as the current display value of the vertical diffusion degree Sy (step S005).

An initial value Sx_ini (for example, 50%) of the horizontal diffusion degree Sx and an initial value Sy_ini (for example, 50%) of the vertical diffusion degree Sy are stored in the storage region of the storage circuit 223 of the control device 200. For example, after the initial activation of the illumination device 1 or after the illumination device 1 activated in a space where pairing is possible is registered as a control target device, the following processing may be performed in which, in place of the above-described processing at steps S003 to S005, the initial value (for example, Sx_ini=50% illustrated in FIG. 21) of the horizontal diffusion degree Sx is set as the current display value of the horizontal diffusion degree Sx, the initial value (for example, Sy_ini=50% illustrated in FIG. 21) of the vertical diffusion degree Sy is set as the current display value of the vertical diffusion degree Sy, and the horizontal diffusion degree Sx and the vertical diffusion degree Sy are transmitted as the first setting information (S1x and S1y) to the registered illumination device 1. In this case, the transmission-reception circuit 111 of the illumination device 1 stores, in the storage circuit 113, the first setting information (S1x and S1y) received from the control device 200 as the second setting information (S2x and S2y). In addition, the electrode drive circuit 112 of the illumination device 1 supplies drive voltage corresponding to the second setting information to the drive electrodes 10 and 13 of each liquid crystal cell 2 of the optical element 100.

The control device 200 calculates the current value (display value) x0 of the position of the first slider S1 by using Expression (3) described above based on the horizontal diffusion degree Sx stored in the storage region of the storage circuit 223, calculates the current value (display value) y0 of the position of the second slider S2 by using Expression (6) described above based on the vertical diffusion degree Sy stored in the storage region of the storage circuit 223, and stores the current values x0 and y0 in the storage region of the storage circuit 223 (step S006).

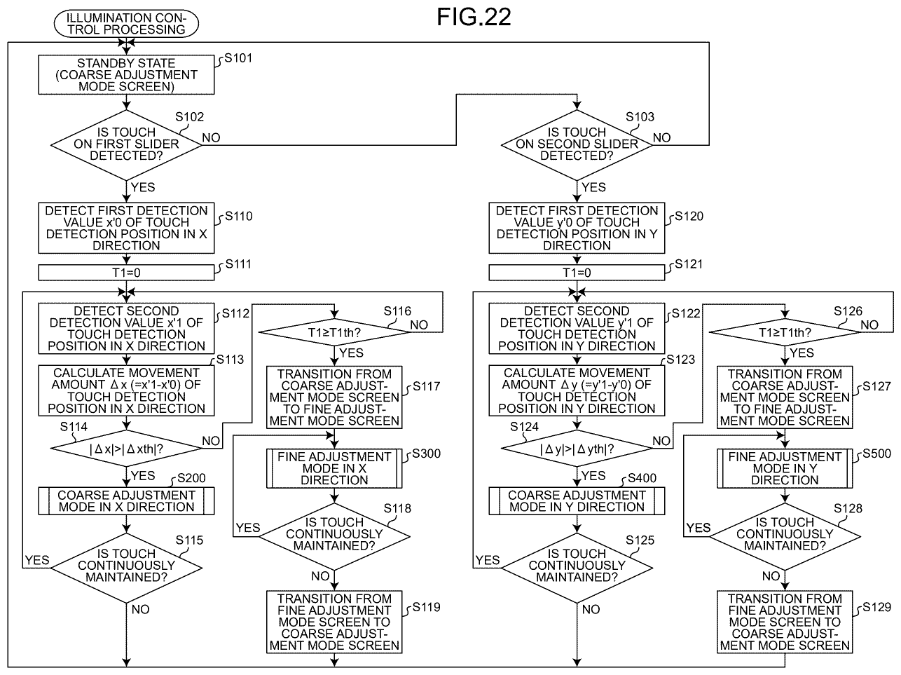

After the processing up to step S006 ends, the process transitions to a standby state on the coarse adjustment mode screen (step S007), and then transitions to illumination control processing illustrated in FIG. 22 (step S100). FIG. 22 is a flowchart illustrating an example of the overall flow of the illumination control processing by the control device 200 for the illumination device 1 according to the first embodiment.

In the standby state on the coarse adjustment mode screen illustrated in FIG. 22 (step S101), the control device 200 executes touch detection processing for the first slider S1 and the second slider S2 (steps S102 and S103).

Specifically, for example, if no touch on the first slider S1 is detected (No at step S102), the control device 200 executes touch detection for the second slider S2 (step S103). The present disclosure is not limited thereto, and the control device 200 may execute touch detection for the first slider S1 when no touch on the second slider S2 is detected.

If no touch on the first slider S1 nor touch on the second slider S2 is detected (No at step S102 or No at step S103), the process returns to the standby state on the coarse adjustment mode screen at step S101 to repeatedly execute the processing from step S101 to step S103. The execution interval of the processing from step S101 to step S103 is, for example, 10 ms.

If a touch on the first slider S1 is detected (Yes at step S102), the control device 200 detects a first detection value x′0 of the touch detection position in the X direction at that moment (step S110) and resets a count value T1 of a first timer (T1=0; step S111).

Subsequently, the control device 200 detects a second detection value x′1 of the touch detection position in the X direction (step S112) and calculates the movement amount (first movement amount) Δx (=x′1−x′0) of the touch detection position in the X direction (step S113).

The control device 200 determines whether the magnitude |Δx| of the movement amount (first movement amount) Δx of the touch detection position in the X direction is larger than the magnitude |Δxth| of the predetermined movement amount threshold Δxth (step S114). The magnitude |Δxth| of the movement amount threshold Δxth of the touch detection position in the X direction is, for example, a value corresponding to the adjustment step (first adjustment step) ΔSxmin in the X direction (that is, the minimum value of the horizontal diffusion degree change amount ΔSx) in the coarse adjustment mode. The magnitude |Δxth| of the movement amount threshold Δxth of the touch detection position in the X direction is not limited thereto and may be a value smaller than the value corresponding to the adjustment step (first adjustment step) ΔSxmin in the X direction (that is, the minimum value of the horizontal diffusion degree change amount ΔSx) in the coarse adjustment mode.

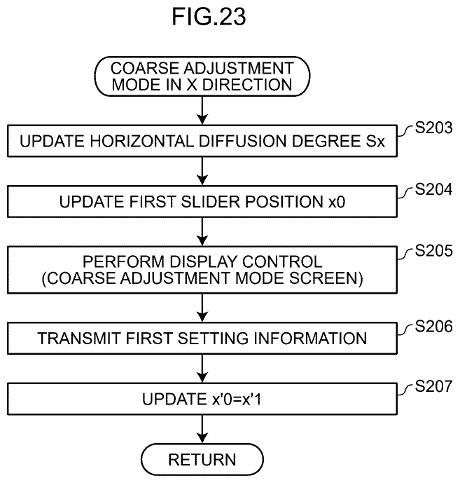

If the magnitude |Δx| of the movement amount (first movement amount) Δx of the touch detection position in the X direction is larger than the magnitude |Δxth| of the predetermined movement amount threshold Δxth (Yes at step S114), the process transitions to the coarse adjustment mode in the X direction illustrated in FIG. 23 (step S200). FIG. 23 is a flowchart illustrating an example of processing by the control device 200 for the illumination device 1 according to the first embodiment in the coarse adjustment mode in the X direction.

After making a transition to the coarse adjustment mode in the X direction illustrated in FIG. 23, the control device 200 updates the horizontal diffusion degree Sx by using Expression (7) below (step S203) and stores the horizontal diffusion degree Sx in the storage region of the storage circuit 223 (refer to FIG. 21).

$$Sx = Sx + Px \times Δ x \qquad ( 7 )$$

In addition, the control device 200 updates the position x0 of the first slider S1 corresponding to the horizontal diffusion degree Sx by using Expression (8) below (step S204) and stores the position x0 in the storage region of the storage circuit 223 (refer to FIG. 21).

$$x 0 = x 0 + Δ x \qquad ( 8 )$$

The display control circuit 231 of the control device 200 applies, to display control on the coarse adjustment mode screen 400, the horizontal diffusion degree Sx updated at step S203 and the position x0 of the first slider S1 updated at step S204 (step S205). Then, the horizontal diffusion degree Sx calculated at step S203 is set as the first setting information (S1x) (S1x=Sx), and the first setting information is transmitted to the illumination device 1 (step S206). Thus, the horizontal diffusion degree Sx can be adjusted with the adjustment step (first adjustment step) ΔSxmin in the X direction (that is, the minimum value of the horizontal diffusion degree change amount ΔSx) in the coarse adjustment mode. Thereafter, the control device 200 updates the second detection value x′1 of the touch detection position in the X direction as the first detection value x′0 (step S207).

Referring back to FIG. 22, the control device 200 determines whether the touch on the first slider S1 is continuously maintained (step S115). If the touch on the first slider S1 is not continuously maintained (No at step S115), the control device 200 returns to the standby state on the coarse adjustment mode screen (step S101). In other words, if the user's finger has moved away from the first slider S1 or is positioned out of the first adjustment region TA1, the control device 200 returns to the standby state on the coarse adjustment mode screen. If the touch on the first slider S1 is continuously maintained (Yes at step S115), the control device 200 executes the processing starting at step S112.

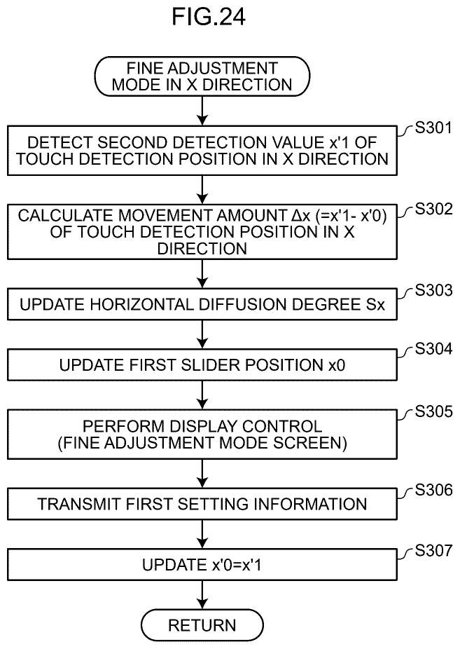

If the magnitude |Δx| of the movement amount (first movement amount) Δx of the touch detection position in the X direction is equal to or smaller than the magnitude |Δxth| of the predetermined movement amount threshold Δxth (No at step S114), the control device 200 subsequently determines whether the count value T1 of the first timer is equal to or greater than the predetermined long-press detection time T1th (for example, 2 sec) (step S116). If the count value T1 of the first timer is less than the predetermined long-press detection time T1th (T1<T1th; No at step S116), the process returns to the processing at step S112. The long-press detection time (first time threshold) T1th is set to, for example, 200 counts (T1th=200) when 10 ms is defined as one count. The long-press detection time (first time threshold) T1th is not limited to 2 sec (=200).
when the count value T1 of the first timer becomes equal to or greater than the predetermined long-press detection time T1th (T1≥T1th; Yes at step S116), specifically in this example, when the count value T1 of the first timer becomes equal to or greater than 200 (T1≥200), the control device 200 transitions from the coarse adjustment mode screen 400 to the fine adjustment mode screen 400A (step S117), thereby transitioning to the fine adjustment mode in the X direction illustrated in FIG. 24 (step S300). Specifically, as illustrated in FIG. 17A or 18A, the fine adjustment mode icon TW indicating that the current adjustment mode is the fine adjustment mode, is displayed. FIG. 24 is a flowchart illustrating an example of processing by the control device 200 for the illumination device 1 according to the first embodiment in the fine adjustment mode in the X direction.

After making a transition to the fine adjustment mode in the X direction illustrated in FIG. 24, the control device 200 detects the second detection value x′1 of the touch detection position in the X direction (step S301), calculates the movement amount (first movement amount) Δx (=x′1−x′0) of the touch detection position in the X direction (step S302), updates the horizontal diffusion degree Sx by using Expression (9) below (step S303), and stores the horizontal diffusion degree Sx in the storage region of the storage circuit 223 (refer to FIG. 21).

$$Sx = Sx + Px \times Δ x \times ( 1 / 10 ) \qquad ( 9 )$$

In addition, the control device 200 updates the position x0 of the first slider S1 corresponding to the horizontal diffusion degree Sx by using Expression (10) below (step S304) and stores the position x0 in the storage region of the storage circuit 223 (refer to FIG. 21).

$$x 0 = x 0 + Δ x \times ( 1 / 10 ) \qquad ( 10 )$$

The coefficient “1/10” in Expressions (9) and (10) described above is an adjustment coefficient provided due to the difference of the adjustment step in the fine adjustment mode from that in the coarse adjustment mode as described above. Specifically, when the adjustment step (first adjustment step) in the coarse adjustment mode, in other words, the adjustment step (first adjustment step) ΔSxmin in the X direction (that is, the minimum value of the horizontal diffusion degree change amount ΔSx) in the coarse adjustment mode is 1%, the adjustment step (second adjustment step) in the fine adjustment mode, in other words, the adjustment step (second adjustment step) ΔSxTWmin in the X direction (that is, the minimum value of the horizontal diffusion degree change amount ΔSxTW) in the fine adjustment mode is set to, for example, 0.1%. This ratio of the adjustment step in the coarse adjustment mode and the adjustment step in the fine adjustment mode is applied as the adjustment coefficient “1/10” in Expressions (9) and (10) described above.

The display control circuit 231 of the control device 200 applies, to display control on the fine adjustment mode screen 400A, the horizontal diffusion degree Sx updated at step S303 and the position x0 of the first slider S1 updated at step S304 (step S305). Then, the horizontal diffusion degree Sx calculated at step S303 is set as the first setting information (S1x) (S1x=Sx) and the first setting information is transmitted to the illumination device 1 (step S306). Accordingly, the horizontal diffusion degree Sx can be adjusted with the adjustment step (second adjustment step) ΔSxTWmin in the X direction (that is, the minimum value of the horizontal diffusion degree change amount ΔSxTW) in the fine adjustment mode. Thereafter, the control device 200 updates the second detection value x′1 of the touch detection position in the X direction as the first detection value x′0 (step S307).

In the coarse adjustment mode (first adjustment mode) in the present disclosure, the width of the light distribution shape object OBJ in the X-axis direction is adjusted in accordance with movement of the first slider S1 in the X direction. However, in the fine adjustment mode (second adjustment mode) according to the first embodiment, the width of the light distribution shape object OBJ in the X-axis direction is adjusted in accordance with the movement amount (first movement amount) of the touch detection position in the X direction in the first adjustment region TA. Thus, in the fine adjustment mode in the X direction illustrated in FIG. 24, the position x0 of the first slider S1 in the display region DA, which is the position x of the intersection point of the X axis and the outline of the light distribution shape object OBJ, is different from the touch detection position x′ in the X direction (x′ #x0) as illustrated in FIG. 19A. As illustrated with a dashed and double-dotted line in FIG. 19A, the display position of the first slider S1 may follow the touch detection position x′ in the X direction in the fine adjustment mode (second adjustment mode). In this case, the first slider S1 may move in accordance with movement of the user's finger and may be separated from the outline of the light distribution shape object OBJ. In this case, a part of the outline intersecting the X axis corresponds to the above-described position x0.

Referring back to FIG. 22, the control device 200 determines whether the touch in the first adjustment region TA1 is continuously maintained (step S118). If the touch in the first adjustment region TA1 is not continuously maintained (No at step S118), a transition from the fine adjustment mode screen 400A to the coarse adjustment mode screen 400 is made (step S119). In other words, if the user's finger has moved away from the screen or is positioned out of the first adjustment region TA1, a transition from the fine adjustment mode screen 400A to the coarse adjustment mode screen 400 is made. After that, the control device 200 returns to the standby state on the coarse adjustment mode screen (step S101). If the touch on the first slider S1 is continuously maintained (Yes at step S118), the control device 200 returns to step S300 in FIG. 22 to repeatedly execute the fine adjustment mode in the X direction illustrated in FIG. 24.

If a touch on the second slider S2 is detected (Yes at step S103), the control device 200 detects a first detection value y′0 of the touch detection position in the Y direction at that moment (step S120) and resets the count value T1 of the first timer (T1=0; step S121).

Subsequently, the control device 200 detects a second detection value y′1 of the touch detection position in the Y direction (step S122) and calculates the movement amount (second movement amount) Δy (=y′1−y′0) of touch detection position in the Y direction (step S123).

The control device 200 determines whether the magnitude |Δy| of the movement amount (second movement amount) Δy of the touch detection position in the Y direction is larger than the magnitude |Δyth| of the predetermined movement amount threshold Δyth (step S124). The magnitude |Δyth| of the movement amount threshold Δyth of the touch detection position in the Y direction is, for example, a value corresponding to the adjustment step (first adjustment step) ΔSymin in the Y direction (that is, the minimum value of the vertical diffusion degree change amount ΔSy) in the coarse adjustment mode. The magnitude |Δyth| of the movement amount threshold Δyth of the touch detection position in the Y direction is not limited thereto and may be a value smaller than the value corresponding to the adjustment step (first adjustment step) ΔSymin in the Y direction (that is, the minimum value of the vertical diffusion degree change amount ΔSy) in the coarse adjustment mode.

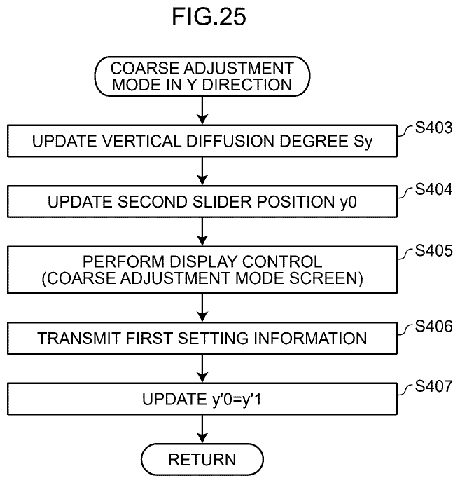

If the magnitude |Δy| of the movement amount (second movement amount) Δy of the touch detection position in the Y direction is larger than the magnitude |Δyth| of the predetermined the movement amount threshold Δyth (Yes at step S124), the process transitions to the coarse adjustment mode in the Y direction illustrated in FIG. 25 (step S400). FIG. 25 is a flowchart illustrating an example of processing by the control device 200 for the illumination device 1 according to the first embodiment in the coarse adjustment mode in the Y direction.

After making a transition to the coarse adjustment mode in the Y direction illustrated in FIG. 25, the control device 200 updates the vertical diffusion degree Sy by using Expression (11) below (step S403) and stores the vertical diffusion degree Sy in the storage region of the storage circuit 223 (refer to FIG. 21).

$$Sy = Sy + Py \times Δ y \qquad ( 11 )$$

In addition, the control device 200 updates the position y0 of the second slider S2 corresponding to the vertical diffusion degree Sy by using Expression (12) below (step S404) and stores the position y0 in the storage region of the storage circuit 223 (refer to FIG. 21).

$$y 0 = y 0 + Δ y \qquad ( 12 )$$

The display control circuit 231 of the control device 200 applies, to display control on the coarse adjustment mode screen 400, the vertical diffusion degree Sy updated at step S403 and the position y0 of the second slider S2 updated at step S404 (step S405). Then, the vertical diffusion degree Sy calculated at step S403 is set as the first setting information (S1y) (S1y=Sy), and the first setting information is transmitted to the illumination device 1 (step S406). Thus, the vertical diffusion degree Sy can be adjusted with the adjustment step (first adjustment step) ΔSymin in the Y direction (that is, the minimum value of the vertical diffusion degree change amount ΔSy) in the coarse adjustment mode. Thereafter, the control device 200 updates the second detection value y′1 of the touch detection position in the Y direction as the first detection value y′0 (step S407).

Referring back to FIG. 22, the control device 200 determines whether the touch on the second slider S2 is continuously maintained (step S125). If the touch on the second slider S2 is not continuously maintained (No at step S125), the control device 200 returns to the standby state on the coarse adjustment mode screen (step S101). In other words, if the user's finger has moved away from the second slider S2 or is positioned out of the second adjustment region TA2, the control device 200 returns to the standby state on the coarse adjustment mode screen. If the touch on the second slider S2 is continuously maintained (Yes at step S125), the control device 200 executes the processing starting at step S122.

If the magnitude |Δy| of the movement amount (second movement amount) Δy of the touch detection position in the Y direction is equal to or smaller than the magnitude |Δyth| of the predetermined the movement amount threshold Δyth (No at step S124), the control device 200 subsequently determines whether the count value T1 of the first timer is equal to or greater than the predetermined long-press detection time T1th (for example, 2 sec) (step S126). If the count value T1 of the first timer is less than the predetermined long-press detection time T1th (T1<T1th; No at step S126), the process returns to the processing at step S122. The long-press detection time (first time threshold) T1th is not limited to 2 sec.

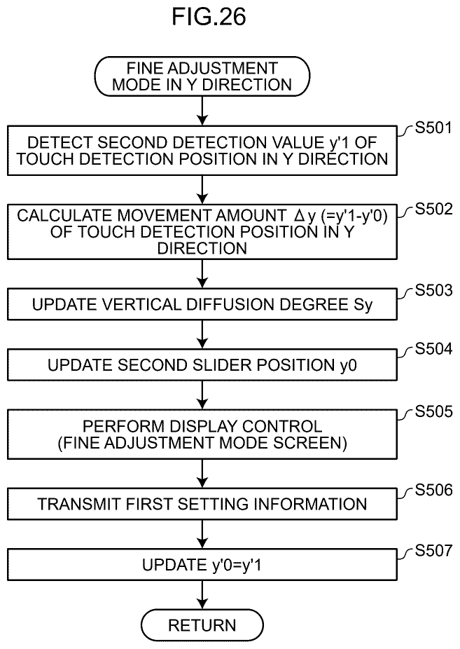

When the count value T1 of the first timer becomes equal to or greater than the predetermined long-press detection time T1th (T1≥T1th; Yes at step S126), the control device 200 transitions from the coarse adjustment mode screen 400 to the fine adjustment mode screen 400A (step S127), thereby transitioning to the fine adjustment mode in the Y direction illustrated in FIG. 26 (step S500). Specifically, as illustrated in FIG. 17B or 18B, the fine adjustment mode icon TW indicating that the current adjustment mode is the fine adjustment mode, is displayed. FIG. 26 is a flowchart illustrating an example of processing by the control device 200 for the illumination device 1 according to the first embodiment in the fine adjustment mode in the Y direction.

After making a transition to the fine adjustment mode in the Y direction illustrated in FIG. 26, the control device 200 detects the second detection value y′1 of the touch detection position in the Y direction (step S501), calculates the movement amount (second movement amount) Δy (=y′1−y′0) of the touch detection position in the Y direction (step S502), updates the vertical diffusion degree Sy by using Expression (13) below (step S503), and stores the vertical diffusion degree Sy in the storage region of the storage circuit 223 (refer to FIG. 21).

$$Sy = Sy + Py \times Δ y \times ( 1 / 10 ) \qquad ( 13 )$$

In addition, the control device 200 updates the position x0 of the second slider S2 corresponding to the vertical diffusion degree Sy by using Expression (14) below (step S504) and stores the position y0 in the storage region of the storage circuit 223 (refer to FIG. 21).

$$y 0 = y 0 + Δ y \times ( 1 / 10 ) \qquad ( 14 )$$

The coefficient “1/10” in Expressions (13) and (14) described above is an adjustment coefficient provided due to the difference of the adjustment step in the fine adjustment mode from that in the coarse adjustment mode as described above. Specifically, when the adjustment step (first adjustment step) in the coarse adjustment mode, in other words, the adjustment step (first adjustment step) ΔSymin in the Y direction (that is, the minimum value of the vertical diffusion degree change amount ΔSy) in the coarse adjustment mode is 1%, the adjustment step (second adjustment step) in the fine adjustment mode, in other words, the adjustment step (second adjustment step) ΔSyTWmin in the Y direction (that is, the minimum value of the vertical diffusion degree change amount ΔSyTW) in the fine adjustment mode is set to, for example, 0.1%. The ratio of the adjustment step in the coarse adjustment mode and the adjustment step in the fine adjustment mode is applied as the adjustment coefficient “1/10” in Expressions (13) and (14) described above.

The display control circuit 231 of the control device 200 applies, to display control on the fine adjustment mode screen 400A, the vertical diffusion degree Sy updated at step S503 and the position Y0 of the second slider S2 updated at step S504 (step S505). Then, the vertical diffusion degree Sy calculated at step S503 is set as the first setting information (S1y) (S1y=Sy) and the first setting information is transmitted to the illumination device 1 (step S506). Accordingly, the vertical diffusion degree Sy can be adjusted with the adjustment step (second adjustment step) ΔSyTWmin in the Y direction (that is, the minimum value of the vertical diffusion degree change amount ΔSyTW) in the fine adjustment mode. Thereafter, the control device 200 updates the second detection value y′1 of the touch detection position in the Y direction as the first detection value y′0 (step S507).

In the coarse adjustment mode (first adjustment mode) in the present disclosure, the width of the light distribution shape object OBJ in the Y-axis direction is adjusted in accordance with movement of the second slider S2 in the Y direction. However, in the fine adjustment mode (second adjustment mode) according to the first embodiment, the width of the light distribution shape object OBJ in the Y-axis direction is adjusted in accordance with the movement amount (second movement amount) of the touch detection position in the Y direction in the second adjustment region TA. Thus, in the fine adjustment mode in the Y direction illustrated in FIG. 26, the position y0 of the second slider S2 in the display region DA, which is the position y of the intersection point of the Y axis and the outline of the light distribution shape object OBJ, is different from the touch detection position y′ in the Y direction (y′≠y0) as illustrated in FIG. 19B. As illustrated with a dashed and double-dotted line in FIG. 19B, the display position of the second slider S2 may follow the touch detection position y′ in the Y direction in the fine adjustment mode (second adjustment mode). In this case, the second slider S2 may move in accordance with movement of the user's finger and may be separated from the outline of the light distribution shape object OBJ. In this case, a part of the outline intersecting the Y axis corresponds to the above-described position y0.

Referring back to FIG. 22, the control device 200 determines whether the touch in the second adjustment region TA2 is continuously maintained (step S128). If the touch in the second adjustment region TA2 is not continuously maintained (No at step S128), a transition from the fine adjustment mode screen 400A to the coarse adjustment mode screen 400 is made (step S129). In other words, if the user's finger has moved away from the screen or is positioned out of the second adjustment region TA2, a transition from the fine adjustment mode screen 400A to the coarse adjustment mode screen 400 is made. After that, the control device 200 returns to the standby state on the coarse adjustment mode screen (step S101). If the touch in the second adjustment region TA2 is continuously maintained (Yes at step S128), the control device 200 returns to step S500 in FIG. 22 to repeatedly execute the fine adjustment mode in the Y direction illustrated in FIG. 26.

The control device 200 for the illumination device 1 according to the first embodiment described above has the coarse adjustment mode (first adjustment mode) in which a setting value (in this example, the diffusion degree of the illumination device 1) is adjusted with the first adjustment steps, and the fine adjustment mode (second adjustment mode) in which the setting value is adjusted with the second adjustment steps finer than those in the coarse adjustment mode. In the coarse adjustment mode, when the long press state of the first slider S1 or the second slider S2 is detected, a transition to the fine adjustment mode is made.

Specifically, after a touch on the first slider S1 on the coarse adjustment mode screen 400 is detected, when the time T1 during which the magnitude |Δx| of the movement amount (first movement amount) Δx of the touch detection position in the X direction in the first adjustment region TA1 remains equal to or smaller than the magnitude |Δxth| of the movement amount threshold Δxth becomes equal to or longer than the long-press detection time (first time threshold) T1th (for example, 2 sec), the transition to the fine adjustment mode in the X direction is made.

After a touch on the second slider S2 on the coarse adjustment mode screen 400 is detected, when the time T1 during which the magnitude |Δy| of the movement amount (second movement amount) Δy of the touch detection position in the Y direction in the second adjustment region TA2 remains equal to or smaller than the magnitude |Δyth| of the movement amount threshold Δyth becomes equal to or longer than the long-press detection time (first time threshold) T1th (for example, 2 sec), the transition to the fine adjustment mode in the Y direction is made.

In this manner, the control device 200 for the illumination device 1 and the illumination system according to the first embodiment can seamlessly transition from the coarse adjustment mode to the fine adjustment mode without any intermediary operation.

Moreover, the control device 200 for the illumination device 1 according to the first embodiment described above can seamlessly transition from the fine adjustment mode to the coarse adjustment mode without any intermediary operation when a touch in the first adjustment region TA1 or the second adjustment region TA2 is no longer continuously maintained in the fine adjustment mode (second adjustment mode).

### Second Embodiment

As described above in the first embodiment, in the fine adjustment mode according to the first embodiment, there may be cases in which the position of the first slider S1 in the display region DA and the touch detection position are different from each other, and the touch detection position moves out of the first adjustment region TA1 or the second adjustment region TA2, depending on the movement amount of the touch detection position, which makes it impossible to perform adjustment in the fine adjustment mode in some cases. In other words, the adjustment range in the fine adjustment mode is restricted by the first adjustment region TAL or the second adjustment region TA2 in some cases.

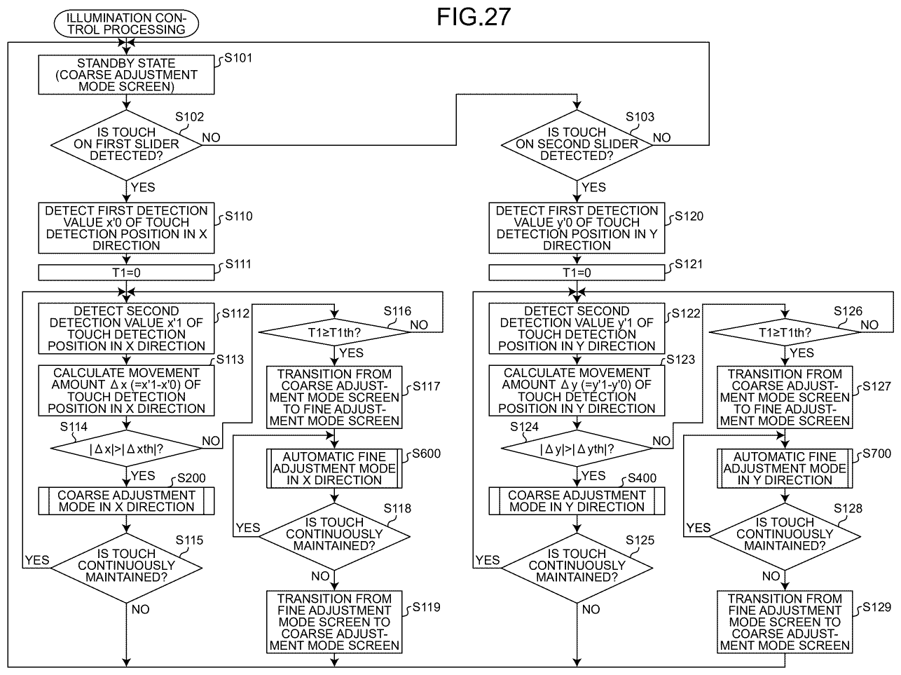

The following describes specific examples of processing by the control device 200 for the illumination device 1 according to a second embodiment. FIG. 27 is a flowchart illustrating an example of the overall flow of illumination control processing by the control device 200 for the illumination device 1 according to the second embodiment. The detailed description is omitted for the same configurations and processing as in the first embodiment, such as the configurations of the illumination device 1 and the control device 200, initial setting processing, and processing in the coarse adjustment mode.

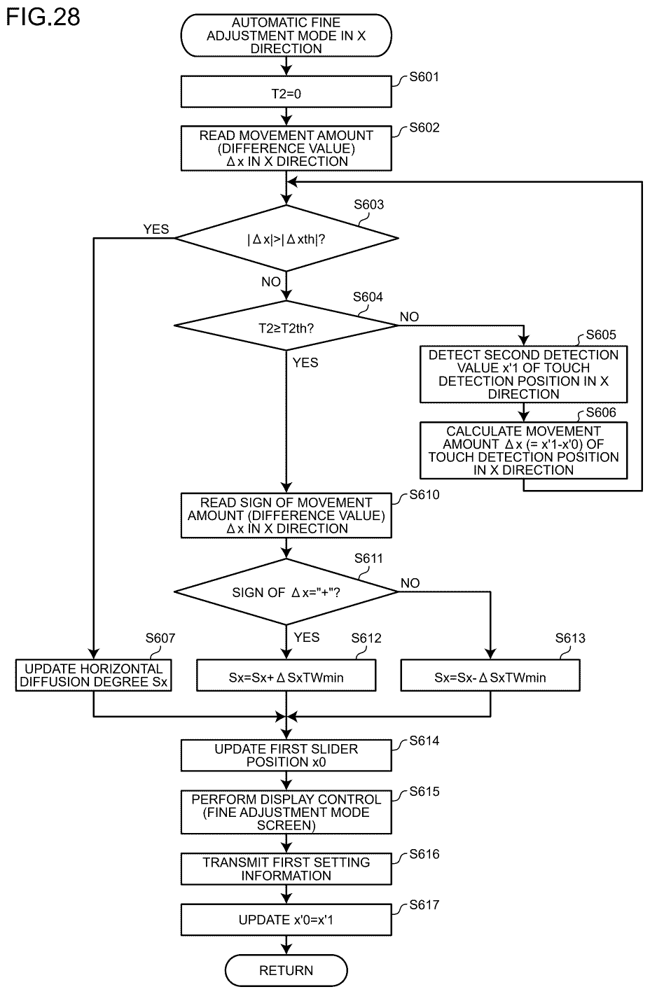

In the illumination control processing by the control device 200 for the illumination device 1 according to the second embodiment illustrated in FIG. 27, after making a transition from the coarse adjustment mode screen 400 to the fine adjustment mode screen 400A (step S117), the control device 200 makes a transition to an automatic fine adjustment mode in the X direction illustrated in FIG. 28 (step S600). FIG. 28 is a flowchart illustrating an example of processing by the control device 200 for the illumination device 1 according to the second embodiment in the automatic fine adjustment mode in the X direction.

After making a transition to the automatic fine adjustment mode in the X direction illustrated in FIG. 28, the control device 200 resets a count value T2 of a second timer (T2=0; step S601) and reads the movement amount (first movement amount) Δx in the X direction from the storage region of the storage circuit 223 (step S602).

The control device 200 determines whether the magnitude |Δx| of the movement amount (first movement amount) Δx of the touch detection position in the X direction is larger than the magnitude |Δxth| of the predetermined movement amount threshold Δxth (step S603).

If the magnitude |Δx| of the movement amount (first movement amount) Δx of the touch detection position in the X direction is equal to or smaller than the magnitude |Δxth| of the predetermined movement amount threshold Δxth (No at step S603), the control device 200 subsequently determines whether the count value T2 of the second timer is equal to or greater than a predetermined setting value change time (second time threshold) T2th (for example, 0.5 sec) (step S604). The setting value change time (second time threshold) T2th is set to, for example, 50 counts (T2th=50) when 10 ms is defined as one count. The setting value change time (second time threshold) T2th is not limited to 0.5 sec (=50).

If the count value T2 of the second timer is less than the predetermined setting value change time T2th (T2<T2th; No at step S604), the control device 200 detects the second detection value x′1 of the touch detection position in the X direction (step S605), calculates the movement amount (first movement amount) Δx (=x′1−x′0) of the touch detection position in the X direction (step S606), and returns to the processing at step S603. More specifically, the processing in the order of steps S604, S605, S606, S603, and S604 is constantly repeated while the count value T2 of the second timer is less than the setting value change time T2th and the magnitude |Δx| of the movement amount Δx of the touch detection position in the X direction is equal to or smaller than the magnitude |Δxth | of the movement amount threshold Δxth. In this process, the second detection value x′1 is always the latest touch detection value. In other words, the processing in the above-described order indicates that the latest position of the finger is constantly monitored, including a case where the finger is completely stationary.

If the magnitude |Δx| of the movement amount (first movement amount) Δx of the touch detection position in the X direction is larger than the magnitude |Δxth| of the predetermined movement amount threshold Δxth (Yes at step S603), the process transitions to the same fine adjustment mode in the X direction as in the first embodiment. Specifically, the horizontal diffusion degree Sx is updated by using Expression (9) described above (step S607) and stored in the storage region of the storage circuit 223 (refer to FIG. 21).

In addition, the control device 200 updates the position x0 of the first slider S1 corresponding to the horizontal diffusion degree Sx by using Expression (10) described above (step S614) and stores the position x0 in the storage region of the storage circuit 223 (refer to FIG. 21).

The display control circuit 231 of the control device 200 applies, to display control on the fine adjustment mode screen 400A, the horizontal diffusion degree Sx updated at step S607 and the position x0 of the first slider S1 updated at step S614 (step S615). Then, the horizontal diffusion degree Sx calculated at step S607 is set as the first setting information (S1x) (S1x=Sx), and the first setting information is transmitted to the illumination device 1 (step S616). Accordingly, the horizontal diffusion degree Sx can be adjusted with the adjustment step (second adjustment step) ΔSxTWmin in the X direction (that is, the minimum value of the horizontal diffusion degree change amount ΔSxTW) in the fine adjustment mode. Thereafter, the control device 200 updates the second detection value x′1 of the touch detection position in the X direction as the first detection value x′0 (step S617).

When the count value T2 of the second timer becomes equal to or greater than the predetermined setting value change time T2th (T2 ≥T2th, Yes at step S604), specifically in this example, when the count value T2 of the second timer becomes equal to or larger than 50 (T2≥50), the automatic fine adjustment mode in the X direction according to the second embodiment is continued.

The control device 200 reads the sign of the movement amount (first movement amount) Δx in the X direction from the storage region of the storage circuit 223 (step S610) and determines the moving direction of the touch detection position in the X direction. Specifically, the control device 200 determines whether the sign of the movement amount (first movement amount) Δx in the X direction is “+” (step S611).

If the sign of the movement amount (first movement amount) Δx in the X direction is “+” (Yes at step S611), it is indicated that the previous moving direction of the touch detection position in the first adjustment region TA1 is a direction in which the horizontal diffusion degree Sx is increased. In this case, the control device 200 updates the current value (display value) of the horizontal diffusion degree Sx by adding the adjustment step (second adjustment step) ΔSxTWmin in the X direction (that is, the minimum value of the horizontal diffusion degree change amount ΔSxTW) in the fine adjustment mode to the current value (display value) of the horizontal diffusion degree Sx (step S612) and stores the updated value in the storage region of the storage circuit 223 (refer to FIG. 21).

If the sign of the movement amount (first movement amount) Δx in the X direction is “−” (No at step S611), it is indicated that the previous moving direction of the touch detection position in the first adjustment region TA1 is a direction in which the horizontal diffusion degree Sx is decreased. In this case, the control device 200 updates the current value (display value) of the horizontal diffusion degree Sx by subtracting the adjustment step (second adjustment step) ΔSxTWmin in the X direction (that is, the minimum value of the horizontal diffusion degree change amount ΔSxTW) in the fine adjustment mode from the current value (display value) of the horizontal diffusion degree Sx (step S613) and stores the updated value in the storage region of the storage circuit 223 (refer to FIG. 21).

The control device 200 updates the position x0 of the first slider S1 corresponding to the horizontal diffusion degree Sx calculated at step S612 or S613 (step S614) and stores the position x0 in the storage region of the storage circuit 223 (refer to FIG. 21). In other words, the width of the light distribution shape object OBJ in the X direction is increased or decreased by a value corresponding to the adjustment step (second adjustment step) ΔSxTWmin in the X direction in the fine adjustment mode.

The display control circuit 231 of the control device 200 applies, to display control on the fine adjustment mode screen 400A, the horizontal diffusion degree Sx updated at step S612 or S613 and the position x0 of the first slider S1 updated at step S614 (step S615). Then, the horizontal diffusion degree Sx calculated at step S612 or S613 is set as the first setting information (S1x) (S1x=Sx), and the first setting information is transmitted to the illumination device 1 (step S616). Accordingly, the horizontal diffusion degree Sx can be adjusted with the adjustment step (second adjustment step) ΔSxTWmin in the X direction (that is, the minimum value of the horizontal diffusion degree change amount ΔSxTW) in the fine adjustment mode. Thereafter, the control device 200 updates the second detection value x′1 of the touch detection position in the X direction as the first detection value x′0 (step S617).

In the coarse adjustment mode (first adjustment mode) in the present disclosure, the width of the light distribution shape object OBJ in the X-axis direction is adjusted in accordance with movement of the first slider S1 in the X direction. However, in the automatic fine adjustment mode (second adjustment mode) according to the second embodiment, a value corresponding to the adjustment step (second adjustment step) ΔSxTWmin in the X direction is added or subtracted each time the setting value change time (second time threshold) T2th elapses. Accordingly, the width of the light distribution shape object OBJ in the X-axis direction is automatically adjusted in accordance with the previous moving direction of the touch detection position in the X direction in the first adjustment region TA1. Thus, in the automatic fine adjustment mode in the X direction illustrated in FIG. 28, there is no correlation between the position x0 of the first slider S1 in the display region DA, which is the position x of the intersection point of the X axis and the outline of the light distribution shape object OBJ, and the touch detection position in the first adjustment region TA1 (x′≠x0).

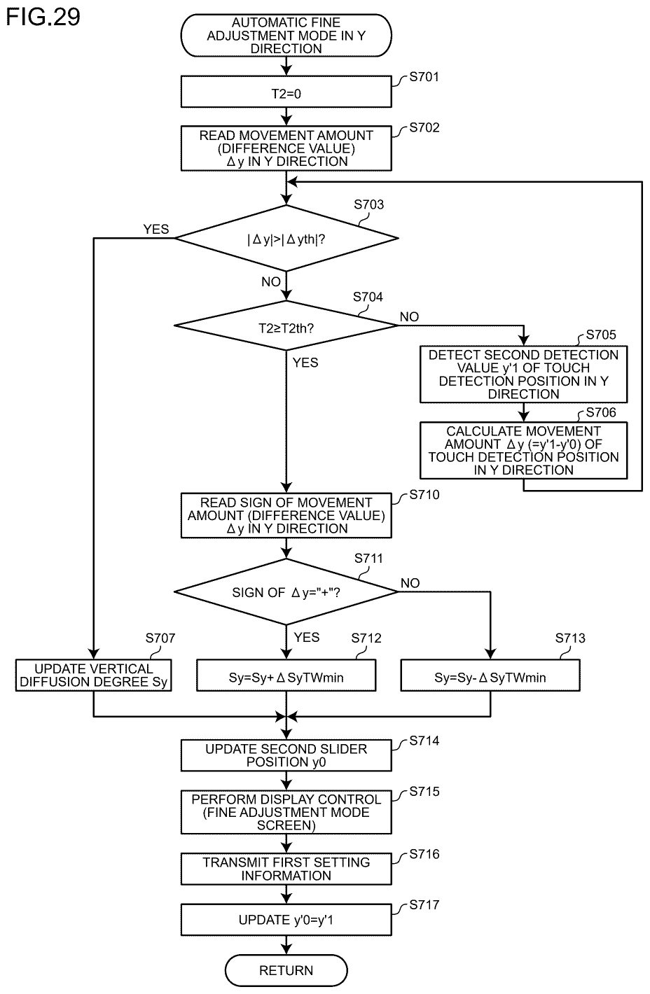

In the illumination control processing illustrated in FIG. 27 by the control device 200 for the illumination device 1 according to the second embodiment, after making a transition from the coarse adjustment mode screen 400 to the fine adjustment mode screen 400A (step S127), the control device 200 transitions to the automatic fine adjustment mode in the Y direction illustrated in FIG. 29 (step S700). FIG. 29 is a flowchart illustrating an example of processing by the control device 200 for the illumination device 1 according to the second embodiment in the automatic fine adjustment mode in the Y direction.

After making a transition to the automatic fine adjustment mode in the Y direction illustrated in FIG. 29, the control device 200 resets the count value T2 of the second timer (T2=0; step S701) and reads the movement amount (second movement amount) Δy in the Y direction from the storage region of the storage circuit 223 (step S702).

The control device 200 determines whether the magnitude |Δy| of the movement amount (second movement amount) Δy of the touch detection position in the Y direction is larger than the magnitude |Δyth| of the predetermined the movement amount threshold Δyth (step S703).

If the magnitude |Δy| of the movement amount (second movement amount) Δy of the touch detection position in the Y direction is equal to or smaller than the magnitude |Δyth| of the predetermined the movement amount threshold Δyth (No at step S703), the control device 200 subsequently determines whether the count value T2 of the second timer is equal to or greater than the predetermined the setting value change time (second time threshold) T2th (for example, 0.5 sec) (step S704). The setting value change time (second time threshold) T2th is set to, for example, 50 counts (T2th=50) when 10 ms is defined as one count. The setting value change time (second time threshold) T2th is not limited to 0.5 sec (=50).

If the count value T2 of the second timer is less than the predetermined setting value change time T2th (T2<T2th; No at step S704), the control device 200 detects the second detection value y′1 of the touch detection position in the Y direction (step S705), calculates the movement amount (second movement amount) Δy (=y′1−y′0) of touch detection position in the Y direction (step S706), and returns to the processing at step S703. More specifically, the processing in the order of steps S704, S705, S706, S703, and S704 is constantly repeated while the count value T2 of the second timer is less than the setting value change time T2th and the magnitude |Δy| of the movement amount Δy of the touch detection position in the Y direction is equal to or smaller than the magnitude |Δyth| of the movement amount threshold Δyth. In this case, the second detection value y′1 is always the latest touch detection value. In other words, the processing in the above-described order indicates that the latest position of the finger is constantly monitored, including a case where the finger is completely stationary.

If the magnitude |Δy| of the movement amount (second movement amount) Δy of the touch detection position in the Y direction is larger than the magnitude |Δyth| of the predetermined the movement amount threshold Δyth (Yes at step S703), the process transitions to the same fine adjustment mode in the Y direction as in the first embodiment. Specifically, the vertical diffusion degree Sy is updated by using Expression (13) described above (step S707) and stored in the storage region of the storage circuit 223 (refer to FIG. 21).

In addition, the control device 200 updates the position y0 of the second slider S2 corresponding to the vertical diffusion degree Sy by using Expression (14) described above (step S714) and stores the position y0 in the storage region of the storage circuit 223 (refer to FIG. 21).

The display control circuit 231 of the control device 200 applies, to display control on the fine adjustment mode screen 400A, the vertical diffusion degree Sy updated at step S707 and the position y0 of the second slider S2 updated at step S714 (step S715). Then, the vertical diffusion degree Sy calculated at step S707 is set as the first setting information (S1y) (S1y=Sy), and the first setting information is transmitted to the illumination device 1 (step S716). Accordingly, the vertical diffusion degree Sy can be adjusted with the adjustment step (second adjustment step) ΔSyTWmin in the Y direction (that is, the minimum value of the vertical diffusion degree change amount ΔSyTW) in the fine adjustment mode. Thereafter, the control device 200 updates the second detection value y′1 of the touch detection position in the Y direction as the first detection value y′0 (step S717).

When the count value T2 of the second timer becomes equal to or greater than the predetermined setting value change time T2th (T2≥T2th; Yes at step S704), specifically in this example, when the count value T2 of the second timer becomes equal to or larger than 50 (T2≥50), the automatic fine adjustment mode in the Y direction according to the second embodiment is continued.

The control device 200 reads the sign of the movement amount (second movement amount) Δy in the Y direction from the storage region of the storage circuit 223 (step S710) and determines the moving direction of the touch detection position in the Y direction. Specifically, the control device 200 determines whether the sign of the movement amount (second movement amount) Δy in the Y direction is “+” (step S711).

If the sign of the movement amount (second movement amount) Δy in the Y direction is “+” (Yes at step S711), it is indicated that the previous moving direction of the touch detection position in the second adjustment region TA2 is a direction in which the vertical diffusion degree Sy is increased. In this case, the control device 200 updates the current value (display value) of the horizontal diffusion degree Sx by adding the adjustment step (second adjustment step) ΔSyTWmin in the Y direction (that is, the minimum value of the vertical diffusion degree change amount ΔSyTW) in the fine adjustment mode to the current value (display value) of the vertical diffusion degree Sy (step S712) and stores the updated value in the storage region of the storage circuit 223 (refer to FIG. 21).

If the sign of the movement amount (second movement amount) Δy in the Y direction is “−” (No at step S711), it is indicated that the previous moving direction of the touch detection position in the second adjustment region TA2 is a direction in which the vertical diffusion degree Sy is decreased. In this case, the control device 200 updates the current value (display value) of the vertical diffusion degree Sy by subtracting the adjustment step (second adjustment step) ΔSyTWmin in the Y direction (that is, the minimum value of the vertical diffusion degree change amount ΔSyTW) in the fine adjustment mode from the current value (display value) of the vertical diffusion degree Sy (step S713) and stores the updated value in the storage region of the storage circuit 223 (refer to FIG. 21).

The control device 200 updates the position y0 of the second slider S2 corresponding to the vertical diffusion degree Sy calculated at step S712 or S713 (step S714) and stores the position y0 in the storage region of the storage circuit 223 (refer to FIG. 21). In other words, the width of the light distribution shape object OBJ in the Y direction is increased or decreased by a value corresponding to the adjustment step (second adjustment step) ΔSyTWmin in the Y direction in the fine adjustment mode.

The display control circuit 231 of the control device 200 applies, to display control on the fine adjustment mode screen 400A, the vertical diffusion degree Sy updated at step S712 or S713 and the position y0 of the second slider S2 updated at step S714 (step S715). Then, the vertical diffusion degree Sy calculated at step S712 or S713 is set as the first setting information (S1y) (S1y=Sy), and the first setting information is transmitted to the illumination device 1 (step S716). Accordingly, the vertical diffusion degree Sy can be adjusted with the adjustment step (second adjustment step) ΔSyTWmin in the Y direction (that is, the minimum value of the vertical diffusion degree change amount ΔSyTW) in the fine adjustment mode. Thereafter, the control device 200 updates the second detection value y′1 of the touch detection position in the Y direction as the first detection value y′0 (step S717).

In the coarse adjustment mode (first adjustment mode) in the present disclosure, the width of the light distribution shape object OBJ in the Y-axis direction is adjusted in accordance with movement of the second slider S2 in the Y direction. However, in the automatic fine adjustment mode (second adjustment mode) according to the second embodiment, a value corresponding to the adjustment step (second adjustment step) ΔSyTWmin in the Y direction is added or subtracted for each elapse of the setting value change time (second time threshold) T2th. Accordingly, the width of the light distribution shape object OBJ in the Y-axis direction is automatically adjusted in accordance with the previous moving direction of the touch detection position in the Y direction in the second adjustment region TA2. Thus, in the automatic fine adjustment mode in the Y direction illustrated in FIG. 29, there is no correlation between the position y0 of the second slider S2 in the display region DA, which is the position y of the intersection point of the Y axis and the outline of the light distribution shape object OBJ, and the touch detection position in the second adjustment region TA2 (y′≠y0).

The control device 200 for the illumination device 1 according to the second embodiment described above has the coarse adjustment mode (first adjustment mode) in which a setting value (in this example, the diffusion degree of the illumination device 1) is adjusted with the first adjustment steps, and the automatic fine adjustment mode (second adjustment mode) in which the setting value is adjusted with the second adjustment steps finer than those in the coarse adjustment mode. In the coarse adjustment mode, when the long press state of the first slider S1 or the second slider S2 is detected, a transition to the automatic fine adjustment mode is made. In this manner, the control device 200 for the illumination device 1 according to the second embodiment can seamlessly transition from the coarse adjustment mode to the automatic fine adjustment mode without any intermediary operation.

Moreover, in the control device 200 for the illumination device 1 according to the second embodiment, after a transition to the automatic fine adjustment mode is made, when the time T2 until the movement amount of the touch detection position in an adjustment region exceeds a predetermined movement amount threshold becomes equal to or greater than the predetermined setting value change time (second time threshold) T2th, the previous moving direction of the touch detection position in the first adjustment region TAL or the second adjustment region TA2 is read from the storage region of the storage circuit 223, and a setting value (in this example, the diffusion degree of the illumination device 1) is automatically adjusted with the second adjustment steps finer than those in the coarse adjustment mode for each elapse of the predetermined setting value change time (second time threshold) T2th. Accordingly, the adjustment range in the fine adjustment mode is not restricted by the first adjustment region TA1 or the second adjustment region TA2, and the setting value can be finely adjusted within the range of 0% to 100%.

Specifically, if the sign of the movement amount (first movement amount), which indicates the previous moving direction of the touch detection position in the X direction in the first adjustment region TA1, corresponds to a direction in which the horizontal diffusion degree Sx is increased, the current value (display value) of the horizontal diffusion degree Sx is increased at predetermined intervals by the adjustment step (second adjustment step) ΔSxTWmin in the X direction (that is, the minimum value of the horizontal diffusion degree change amount ΔSxTW) in the fine adjustment mode. If the sign of the movement amount (first movement amount), which indicates the previous moving direction of the touch detection position in the X direction in the first adjustment region TA1, corresponds to a direction in which the horizontal diffusion degree Sx is decreased, the current value (display value) of the horizontal diffusion degree Sx is decreased for each elapse of the predetermined setting value change time (second time threshold) T2th by the adjustment step (second adjustment step) ΔSxTWmin in the X direction (that is, the minimum value of the horizontal diffusion degree change amount ΔSxTW) in the fine adjustment mode. Thus, in the automatic fine adjustment mode according to the second embodiment, the direction of automatic adjustment of the horizontal diffusion degree Sx can be seamlessly changed from “+” to “−” or from “−” to “+” each time the sign of the movement amount (first movement amount), which indicates the previous moving direction of the touch detection position in the X direction in the first adjustment region TA1, is updated. Accordingly, the direction of automatic adjustment of the horizontal diffusion degree Sx can be seamlessly changed without large movement of the user' finger touching in the first adjustment region TA1.

If the sign of the movement amount (second movement amount), which indicates the previous moving direction of the touch detection position in the Y direction in the second adjustment region TA2, corresponds to a direction in which the vertical diffusion degree Sy is increased, the current value (display value) of the vertical diffusion degree Sy is increased at predetermined intervals by the adjustment step (second adjustment step) ΔSyTWmin in the Y direction (that is, the minimum value of the vertical diffusion degree change amount ΔSyTW) in the fine adjustment mode. If the sign of the movement amount (second movement amount), which indicates the previous moving direction of the touch detection position in the Y direction in the second adjustment region TA2, corresponds to a direction in which the vertical diffusion degree Sy is decreased, the current value (display value) of the vertical diffusion degree Sy is decreased for each elapse of the predetermined setting value change time (second time threshold) T2th by the adjustment step (second adjustment step) ΔSyTWmin in the Y direction (that is, the minimum value of the vertical diffusion degree change amount ΔSyTW) in the fine adjustment mode. Thus, in the automatic fine adjustment mode according to the second embodiment, the direction of automatic adjustment of the vertical diffusion degree Sy can be seamlessly changed from “+” to “−” or from “−” to “+” each time the sign of the movement amount (second movement amount), which indicates the previous moving direction of the touch detection position in the Y direction in the second adjustment region TA2, is updated. Accordingly, the direction of automatic adjustment of the vertical diffusion degree Sy can be seamlessly changed without large movement of the user's finger touching in the second adjustment region TA2.

Moreover, as in the first embodiment, the control device 200 for the illumination device 1 according to the second embodiment described above can make a seamless transition from the automatic fine adjustment mode to the coarse adjustment mode without any intermediary operation when touch in the first adjustment region TA1 or the second adjustment region TA2 is no longer continuously maintained in the automatic fine adjustment mode (second adjustment mode).

The preferable embodiments of the present disclosure are described above, but the present disclosure is not limited to the embodiments. Contents disclosed in the embodiments are merely exemplary and may be modified in various kinds of manners without departing from the scope of the present disclosure. Appropriate modifications made without departing from the scope of the present disclosure naturally belong to the technical scope of the present disclosure.

What is claimed is:

1. A control device for an illumination device that is configured to control a plurality of illumination devices each capable of setting a light distribution shape of light emitted from a light source in two directions of a first direction and a second direction intersecting the first direction, the control device comprising:
a touch sensor including a detection region in which a plurality of detection elements are provided;
a display panel provided with a display region that overlaps the detection region of the touch sensor in a plan view and configured to display an adjustment screen for the light distribution shape in the display region; and
a storage circuit configured to store a first detection value and a second detection value, the first detection value being detected at a first time in an adjustment region provided on the adjustment screen, the second detection value being detected at a second time later than the first time in the adjustment region, wherein
the control device has
a first adjustment mode in which the light distribution shape is adjusted with a first adjustment step, and
a second adjustment mode in which the light distribution shape is adjusted with a second adjustment step narrower than the first adjustment step, and
when a time during which the magnitude of a movement amount of a touch detection position calculated by subtracting the first detection value from the second detection value remains equal to or smaller than a predetermined movement amount threshold becomes equal to or longer than a predetermined first time threshold in the first adjustment mode, a transition to the second adjustment mode is made.

2. The control device for an illumination device according to claim 1, wherein
in the adjustment region, at least one direction of the light distribution shape is adjustable from a minimum value to a maximum value in the first adjustment mode, and
a one-step scale of the second adjustment step in the adjustment region is equal to a one-step scale of the first adjustment step in the adjustment region.

3. The control device for an illumination device according to claim 1, wherein
the adjustment screen is defined by an XY plane having an X direction corresponding to the first direction, a Y direction corresponding to the second direction, and having an origin at a predetermined position on the adjustment screen, and
the adjustment region includes
a first adjustment region in which the light distribution shape is adjustable in the X direction, and
a second adjustment region in which the light distribution shape is adjustable in the Y direction.

4. The control device for an illumination device according to claim 3, wherein
the adjustment screen is provided with
a light distribution shape object having a center point at the origin of the XY plane,
a first slider provided in the first adjustment region and having a center point at an intersection point of an X axis of the XY plane and an outline of the light distribution shape object, and
a second slider provided in the second adjustment region and having a center point at an intersection point of a Y axis of the XY plane and the outline of the light distribution shape object, and
in the first adjustment mode,
a width of the light distribution shape object in an X-axis direction is adjusted in accordance with movement of the first slider in the X direction, the movement being detected by touch in the first adjustment region, and
a width of the light distribution shape object in a Y-axis direction is adjusted in accordance with movement of the second slider in the Y direction, the movement being detected by touch in the second adjustment region.

5. The control device for an illumination device according to claim 4, wherein in the second adjustment mode,
when a touch state in the first adjustment region is continuously maintained, the width of the light distribution shape object in the X-axis direction is adjusted in accordance with the magnitude of a first movement amount calculated by subtracting a first detection value detected in the first adjustment region from a second detection value detected in the first adjustment region, and
when a touch state in the second adjustment region is continuously maintained, the width of the light distribution shape object in the Y-axis direction is adjusted in accordance with the magnitude of a second movement amount calculated by subtracting a first detection value detected in the second adjustment region from a second detection value detected in the second adjustment region.

6. The control device for an illumination device according to claim 1, wherein in the second adjustment mode, when a time until the magnitude of the movement amount exceeds a predetermined movement amount threshold becomes equal to or longer than a predetermined second time threshold, a setting value of the light distribution shape is
increased by the second adjustment step in a case where the movement amount is a positive value, and
decreased by the second adjustment step in a case where the movement amount is a negative value.

7. The control device for an illumination device according to claim 6, wherein in the adjustment region,
at least one direction of the light distribution shape is adjustable within a range from a minimum value to a maximum value in the first adjustment mode, and
when a time until the magnitude of the movement amount exceeds a predetermined movement amount threshold is shorter than a predetermined second time threshold in the second adjustment mode, a one-step scale of the second adjustment step in the adjustment region is equal to a one-step scale of the first adjustment step in the adjustment region.

8. The control device for an illumination device according to claim 1, wherein when a time until the magnitude of the movement amount exceeds a predetermined movement amount threshold becomes equal to or longer than a predetermined second time threshold in the second adjustment mode, a setting value of the light distribution shape is
increased by the second adjustment step for each elapse of the second time threshold in a case where the movement amount is a positive value, and
decreased by the second adjustment step for each elapse of the second time threshold in a case where the movement amount is a negative value.

9. The control device for an illumination device according to claim 8, wherein in the adjustment region,
at least one direction of the light distribution shape is adjustable within a range from a minimum value to a maximum value in the first adjustment mode, and
when a time until the magnitude of the movement amount exceeds a predetermined movement amount threshold is shorter than a predetermined second time threshold in the second adjustment mode, a one-step scale of the second adjustment step in the adjustment region is equal to a one-step scale of the first adjustment step in the adjustment region.

10. The control device for an illumination device according to claim 6, wherein
the adjustment screen is defined by an XY plane having an X direction corresponding to the first direction, a Y direction corresponding to the second direction, and an origin at a predetermined position on the adjustment screen, and
the adjustment region includes
a first adjustment region in which the light distribution shape is adjustable in the X direction, and
a second adjustment region in which the light distribution shape is adjustable in the Y direction.

11. The control device for an illumination device according to claim 10, wherein
the adjustment screen is provided with
a light distribution shape object having a center point at the origin of the XY plane,
a first slider provided in the first adjustment region and having a center point at an intersection point of an X axis of the XY plane and an outline of the light distribution shape object, and
a second slider provided in the second adjustment region and having a center point at an intersection point of a Y axis of the XY plane and the outline of the light distribution shape object, and
in the first adjustment mode,
a width of the light distribution shape object in an X-axis direction is adjusted in accordance with movement of the first slider in the X direction, the movement being detected by touch in the first adjustment region, and
a width of the light distribution shape object in a Y-axis direction is adjusted in accordance with movement of the second slider in the Y direction, the movement being detected by touch in the second adjustment region.

12. The control device for an illumination device according to claim 11, wherein in the second adjustment mode,
when a time until the magnitude of a first movement amount calculated by subtracting a first detection value detected in the first adjustment region from a second detection value detected in the first adjustment region exceeds the movement amount threshold is equal to or longer than the second time threshold and a touch state in the first adjustment region is continuously maintained, the width of the light distribution shape object in the X-axis direction is
increased by a value corresponding to the second adjustment step in the X direction for each elapse of the second time threshold in a case where the first movement amount is a positive value, and
decreased by a value corresponding to the second adjustment step in the X direction for each elapse of the second time threshold in a case where the first movement amount is a negative value, and
when a time until the magnitude of a second movement amount calculated by subtracting a first detection value detected in the second adjustment region from a second detection value detected in the second adjustment region exceeds the movement amount threshold is equal to or longer than the second time threshold and a touch state in the second adjustment region is continuously maintained, the width of the light distribution shape object in the Y-axis direction is
increased by a value corresponding to the second adjustment step in the Y direction for each elapse of the second time threshold in a case where the second movement amount is a positive value, and
decreased by a value corresponding to the second adjustment step in the Y direction for each elapse of the second time threshold in a case where the second movement amount is a negative value.

13. The control device for an illumination device according to claim 12, wherein in the second adjustment mode,
when a time until the magnitude of the first movement amount exceeds the movement amount threshold is shorter than the second time threshold and a touch state in the first adjustment region is continuously maintained, the width of the light distribution shape object in the X-axis direction is adjusted in accordance with the first movement amount, and
when a time until the magnitude of the second movement amount exceeds the movement amount threshold is shorter than the second time threshold and a touch state in the second adjustment region is continuously maintained, the width of the light distribution shape object in the Y-axis direction is adjusted in accordance with the second movement amount.

14. The control device for an illumination device according to claim 8, wherein
the adjustment screen is defined by an XY plane having an X direction corresponding to the first direction, a Y direction corresponding to the second direction, and an origin at a predetermined position on the adjustment screen, and
the adjustment region includes
a first adjustment region in which the light distribution shape is adjustable in the X direction, and
a second adjustment region in which the light distribution shape is adjustable in the Y direction.

15. The control device for an illumination device according to claim 14, wherein
the adjustment screen is provided with
a light distribution shape object having a center point at the origin of the XY plane,
a first slider provided in the first adjustment region and having a center point at an intersection point of an X axis of the XY plane and an outline of the light distribution shape object, and
a second slider provided in the second adjustment region and having a center point at an intersection point of a Y axis of the XY plane and the outline of the light distribution shape object, and
in the first adjustment mode,
a width of the light distribution shape object in an X-axis direction is adjusted in accordance with movement of the first slider in the X direction, the movement being detected by touch in the first adjustment region, and
a width of the light distribution shape object in a Y-axis direction is adjusted in accordance with movement of the second slider in the Y direction, the movement being detected by touch in the second adjustment region.

16. The control device for an illumination device according to claim 15, wherein in the second adjustment mode,
when a time until the magnitude of a first movement amount calculated by subtracting a first detection value detected in the first adjustment region from a second detection value detected in the first adjustment region exceeds the movement amount threshold is equal to or longer than the second time threshold and a touch state in the first adjustment region is continuously maintained, the width of the light distribution shape object in the X-axis direction is
increased by a value corresponding to the second adjustment step in the X direction for each elapse of the second time threshold in a case where the first movement amount is a positive value, and
decreased by a value corresponding to the second adjustment step in the X direction for each elapse of the second time threshold in a case where the first movement amount is a negative value, and
when a time until the magnitude of a second movement amount calculated by subtracting a first detection value detected in the second adjustment region from a second detection value detected in the second adjustment region exceeds the movement amount threshold is equal to or longer than the second time threshold and a touch state in the second adjustment region is continuously maintained, the width of the light distribution shape object in the Y-axis direction is
increased by a value corresponding to the second adjustment step in the Y direction for each elapse of the second time threshold in a case where the second movement amount is a positive value, and
decreased by a value corresponding to the second adjustment step in the Y direction for each elapse of the second time threshold in a case where the second movement amount is a negative value.

17. The control device for an illumination device according to claim 16, wherein in the second adjustment mode,
when a time until the magnitude of the first movement amount exceeds the movement amount threshold is shorter than the second time threshold and a touch state in the first adjustment region is continuously maintained, the width of the light distribution shape object in the X-axis direction is adjusted in accordance with the first movement amount, and
when a time until the magnitude of the second movement amount exceeds the movement amount threshold is shorter than the second time threshold and a touch state in the second adjustment region is continuously maintained, the width of the light distribution shape object in the Y-axis direction is adjusted in accordance with the second movement amount.
